(19) United States
(12) Patent Application Publication
(10) Pub. No.: US 2024/0166075 A1
(43) Pub. Date: May 23, 2024

(54) AUTOMATIC INSPECTION AND LOCKING FOR AN ELECTRIC VEHICLE CHARGING STATION

(71) Applicant: Amazon Technologies, Inc., Seattle, WA (US)

(72) Inventors: Mike MacGregor, Seattle, WA (US); Bhavik Patel, Plymouth, MN (US); David Lee Coats, Bellevue, WA (US)

(73) Assignee: Amazon Technologies, Inc., Seattle, WA (US)

(21) Appl. No.: 18/056,540

(22) Filed: Nov. 17, 2022

(51) Int. Cl. B60L 53/65; B60L 53/16; B60L 53/30

(52) U.S. Cl. CPC B60L 53/65; B60L 53/16; B60L 53/30

(57) ABSTRACT

An electric vehicle supply equipment (EVSE) holster including a locking mechanism and an image capture device is described herein. The image capture device is configured to capture image data relating to a connector face of the charging connector when the charging connector is inserted into the holster. The image data is then analyzed to determine if a physical abnormality is present on the charging connector (for example, damage to the charging connector or debris lodged in the charging connector. If a physical abnormality is detected, the locking mechanism is actuated to lock the charging connector to the holster until maintenance is performed on the charging connector.

### BACKGROUND

An electric vehicle supply equipment (EVSE) (also referred to as a “charging station” or a “charging dock”) is a system used to supply electric energy to recharge one or more batteries of an electric vehicle (EV). For example, EVSE systems may include electrical conductors, related equipment, software, and communication protocols that deliver energy efficiently to the EV.

Charging cables and connectors are critical, high-value components which may experience consistent human use (and misuse) on a daily basis throughout the life of the EVSE. These charging cables and connectors have the potential to be damaged during their lifetimes. As one example, a charging connector may be cracked and unable to properly function. As another example, a small rock or dirt may be lodged in a connector's socket. A human operator tasked with inspecting the connectors for damage may not be able to identify such damage as soon as it occurs.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIGS. 1A-1C depict an example holster and charging connector for an electric vehicle supply equipment (EVSE) in accordance with one or more example embodiments of the disclosure.

FIG. 1D depicts the latch of the charging connector in accordance with one or more example embodiments of the disclosure.

FIG. 1E depicts the latch of the charging connector inserted into the holster in accordance with one or more example embodiments of the disclosure.

FIG. 1F depicts example charging connector faces including different target icons in accordance with one or more example embodiments of the disclosure.

FIGS. 2A-2B depict an example locking mechanism for an EVSE in accordance with one or more example embodiments of the disclosure.

FIGS. 3A-3B depict perspective views of an example holster and charging connector for an EVSE in accordance with one or more example embodiments of the disclosure.

FIGS. 4A-4B depict an example wiring harness positioned on a locking mechanism for an EVSE in accordance with one or more example embodiments of the disclosure.

FIGS. 4C-4D depict partial cross-section views illustrating the operation of the locking mechanism location detection connectors in accordance with one or more example embodiments of the disclosure.

FIG. 5 depicts another example holster for an electric vehicle supply equipment (EVSE) in accordance with one or more example embodiments of the disclosure.

FIG. 6 depicts example internal components of a holster in accordance with one or more example embodiments of the disclosure.

FIGS. 7A-7B depicts an example holster housing for an EVSE in accordance with one or more example embodiments of the disclosure.

FIG. 7C depicts a partial cross-section of an example holster housing in accordance with one or more example embodiments of the disclosure.

FIGS. 7D-7E depict partial cross-section views of an example holster housing showing an engagement of a charging connector latch with the holster housing in accordance with one or more example embodiments of the disclosure

FIG. 8 depicts an example image capture device for an EVSE in accordance with one or more example embodiments of the disclosure.

FIG. 9 depicts an example locking mechanism cover in accordance with one or more example embodiments of the disclosure.

FIG. 10 depicts an example wiring harness in accordance with one or more example embodiments of the disclosure.

FIG. 11 depicts an example bulkhead in accordance with one or more example embodiments of the disclosure.

FIG. 12 depicts an example EVSE system in accordance with one or more example embodiments of the disclosure.

FIG. 13 depicts an example flow diagram in accordance with one or more example embodiments of the disclosure

FIG. 14 is a schematic block diagram of an illustrative device in accordance with one or more example embodiments of the disclosure.

### DETAILED DESCRIPTION

### Overview

This disclosure relates to, among other things, devices, systems, methods, computer-readable media, techniques, and methodologies for automatic inspection and locking of an EVSE. Particularly, a holster of the EVSE (for example, the portion of the EVSE in which the charging connectors may be inserted when not in use for charging an EV) may include one or more internal locking mechanisms for locking a charging connector to the holster if the charging connector is determined to be damaged (or otherwise is associated with any other type of physical abnormality). The charging connector is locked into the holster to prevent further use of the damaged charging connector before maintenance is performed. This determination may be made based on images (any reference to “images” herein may similarly include videos as well) of the charging connector that are captured by an image capture device that is also provided within the holster. These images may be automatically analyzed by a system to make such determinations (for example, using computer vision techniques, machine learning models, or the like). The locking mechanism may remain in the locked position until it is determined that the damage to the charging connector has been fixed or an authorized technician is at the location of the charging connector to remove the charging connector from the holster to repair the charging connector.

At a high-level, example methodology may include at least the following. When a user properly returns the EVSE connector to the holster, the camera within the holster illuminates the connection face (for example, using infra-red illumination and/or any other wavelength of illumination) and captures a high-resolution image of the connector. This connector face image may be uploaded to an external system (for example, an external server) which may analyze the image for physical abnormalities, such as cracks, warpage, or other permanent damage (for example, using artificial intelligence, machine learning, or the like). The external system may then return a different value depending on the result of the analysis. For example, the external system may return a value of one if the connection is damaged and a value of zero if the connection is not damaged (however, this is merely exemplary). If the value returned is a one, then an automated lock may be set so that the connector cannot be used until the required EVSE maintenance is completed and the fault is cleared. Additional details about the hardware and associated methodology are provided below with respect to the figures.

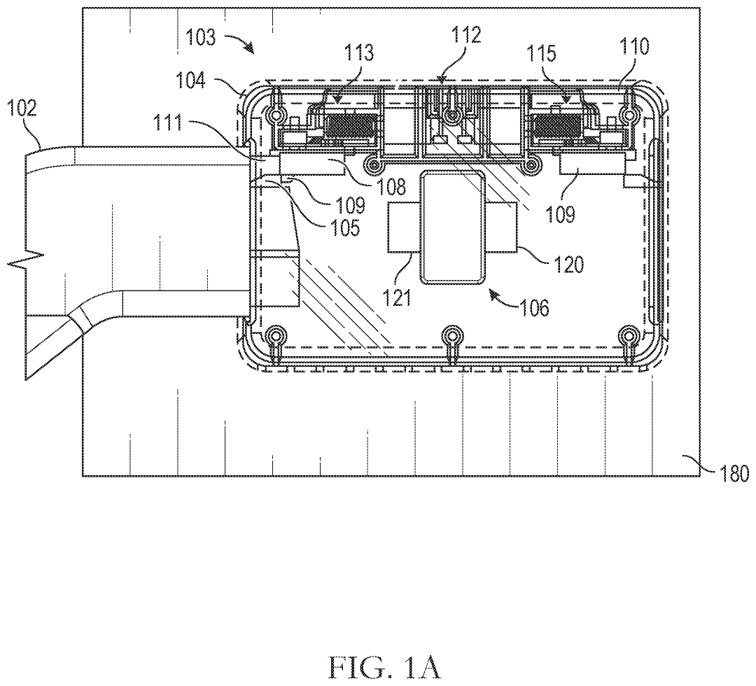

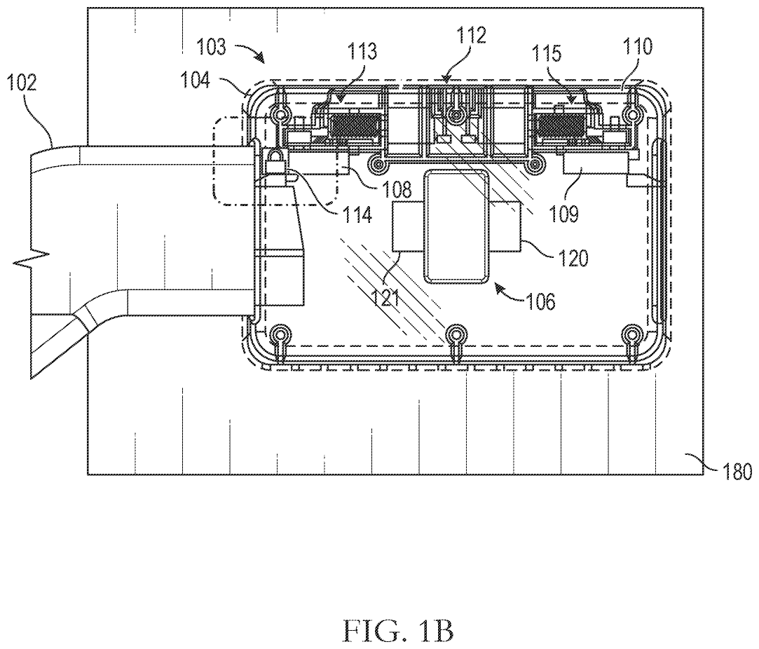

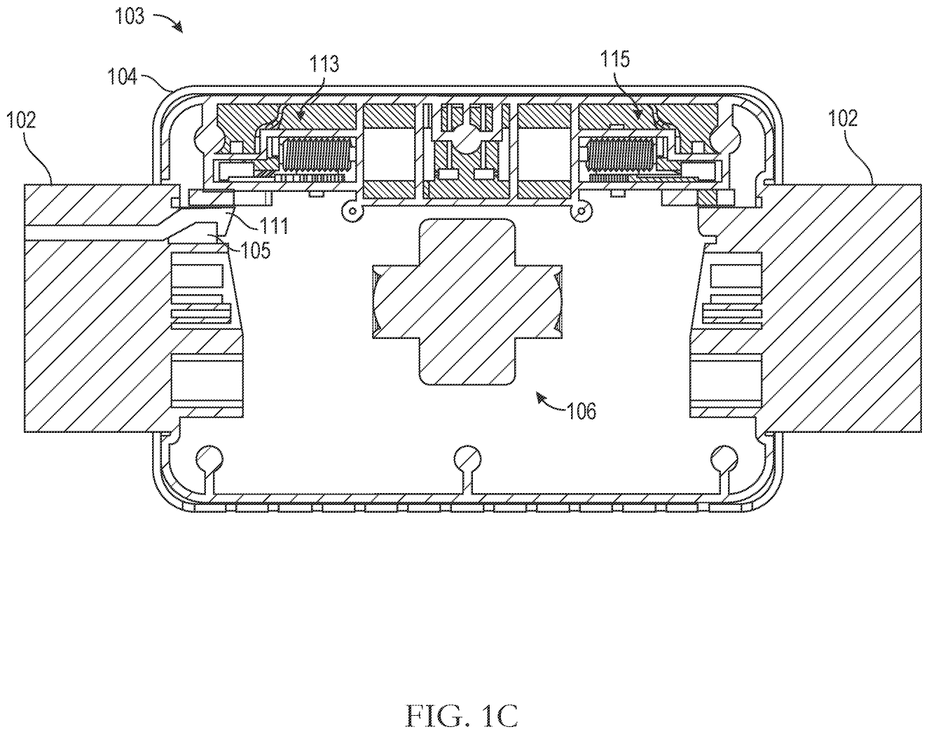

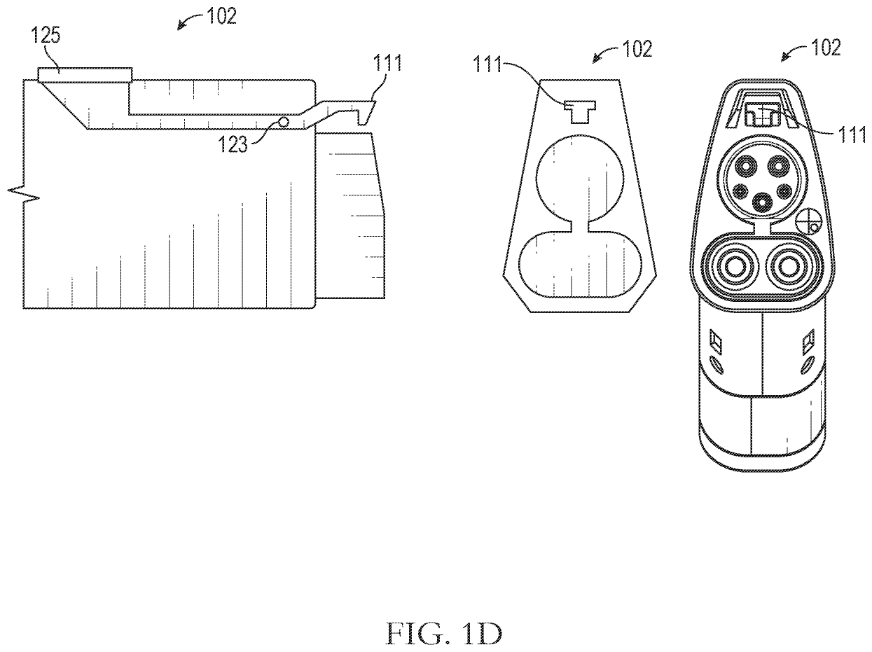

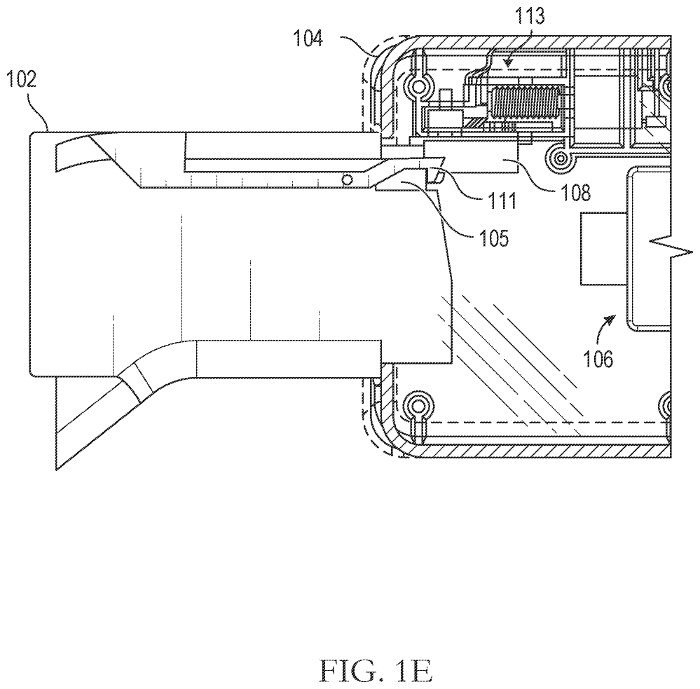

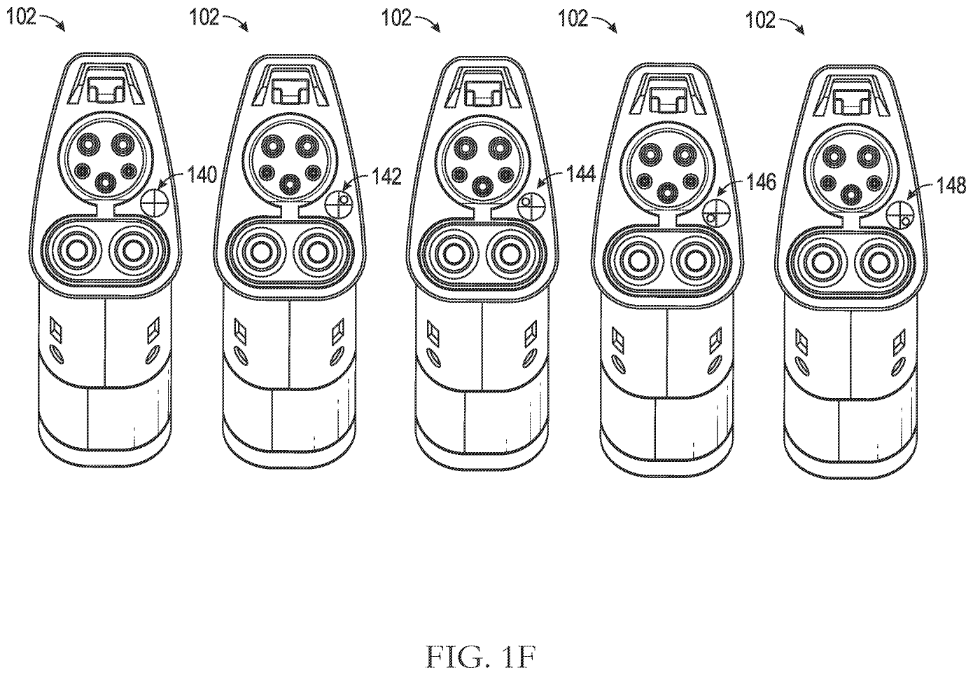

Turning to the figures, FIGS. 1A-1B depict an example holster 103 and charging connector 102 for an electric vehicle supply equipment (EVSE) in accordance with one or more example embodiments of the disclosure.

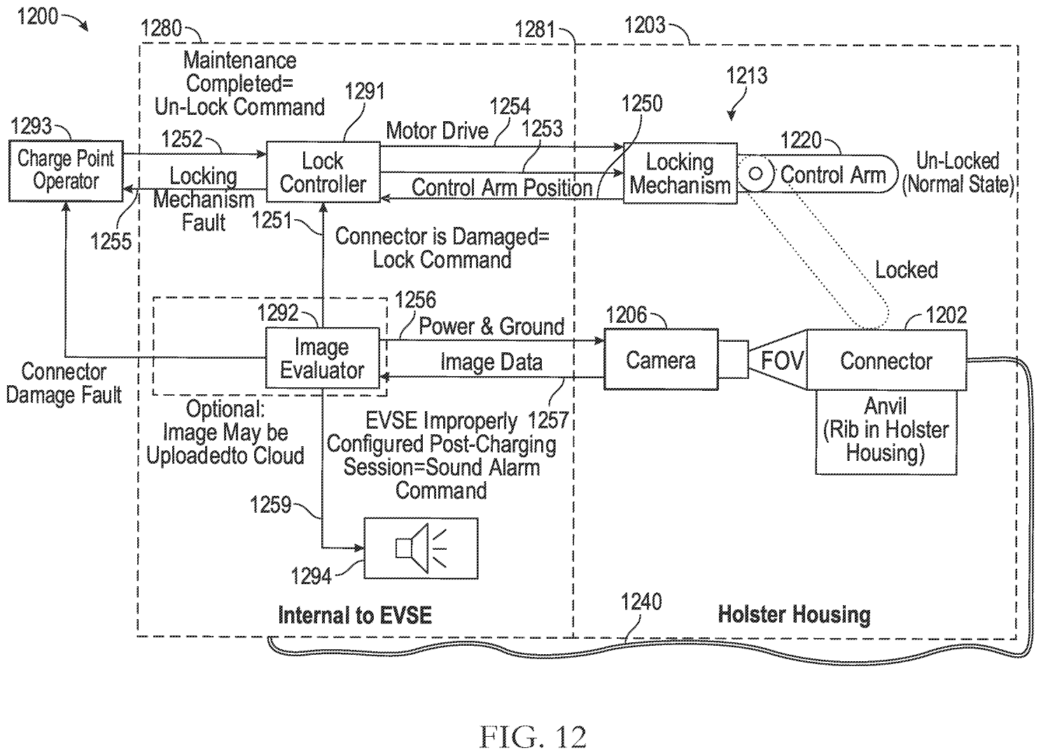

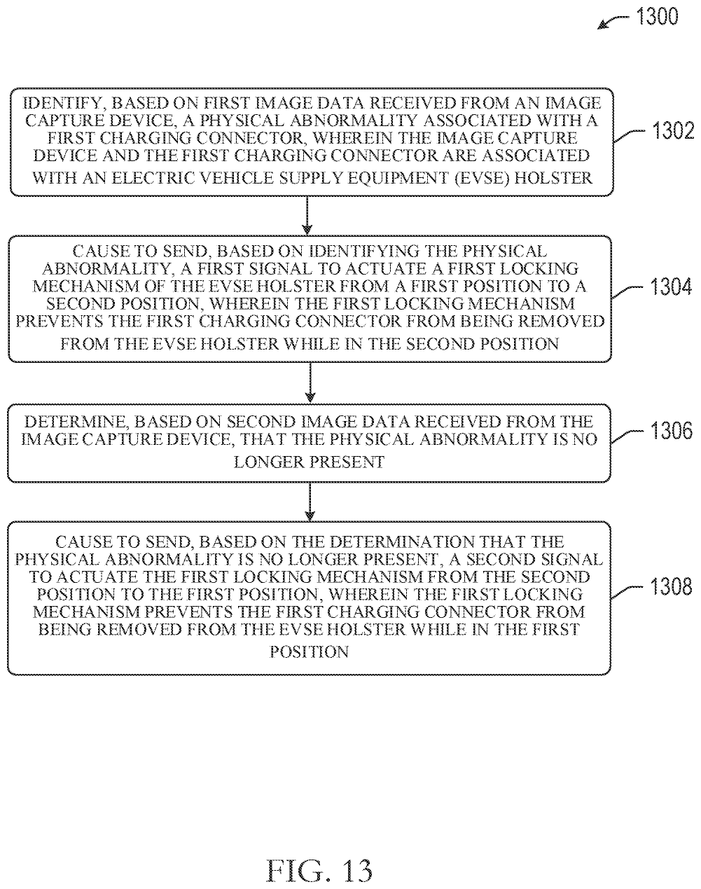

The charging connector 102 may be a component of the EVSE that is inserted into a charging port located on an EV for purposes of transferring power to the EV from the EVSE to charge the EV. Once the charging process has been completed, the user may return the charging connector 102 to the holster 103 for storage on the EVSE until the charging connector 102 is used by another user to charge another EV. The holster 103 may be mounted to a bulkhead 180 of the EVSE, which may separate the holster 103 from a main body of the EVSE (not shown in this figure, but illustrated in FIG. 12). The charging connector may include any type of charging connector compatible with any type of EV plug. For example, the charging connector may be compatible with Type 1 or Type 2 alternating current (AC) plugs, combined charging system (CCS) or CHAdeMO direct current (DC) plugs, and/or any other types of plugs that may be included on an EV.

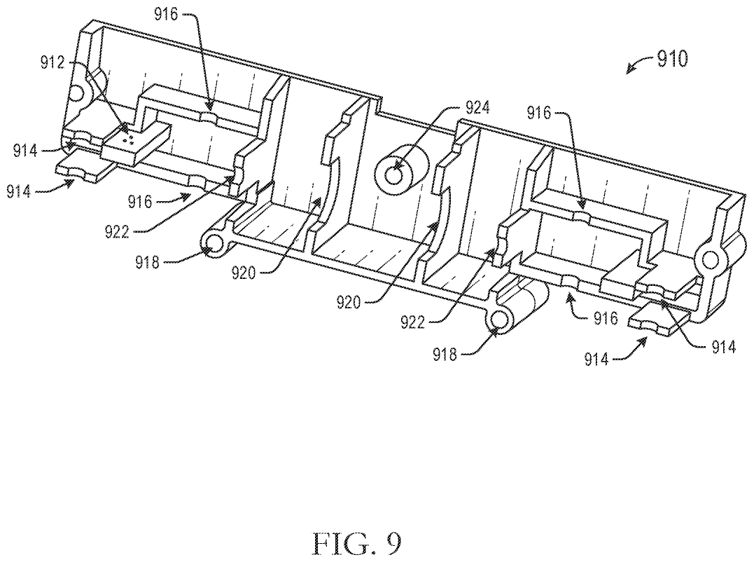

The holster 103 may include one or more locking mechanisms (for example, locking mechanism 113, locking mechanism 115, and/or any other number of locking mechanisms). In one or more embodiments, the locking mechanisms may be mounted to a locking mechanism cover 110, which may be a physical structure provided within the holster 103 (however, this is not necessarily required and not intended to be limiting). Further details about the locking mechanism cover 110 are provided in the description associated with FIG. 9.

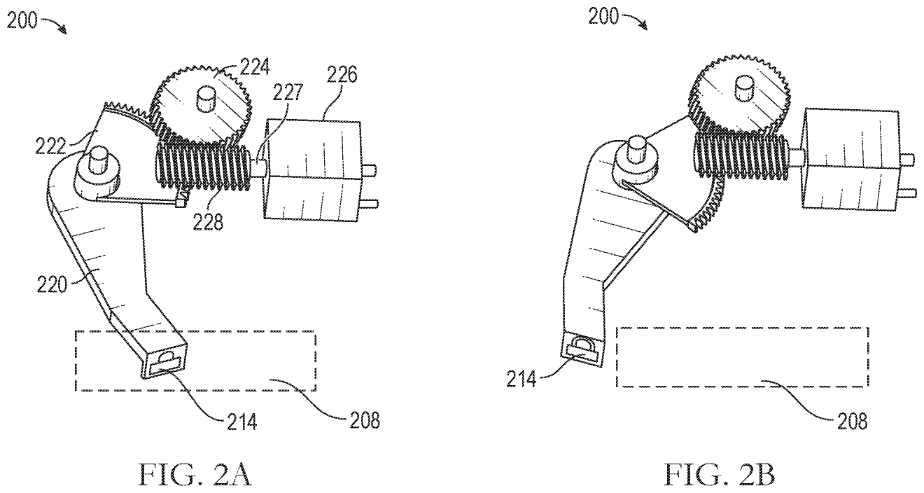

A locking mechanism may be configured to actuate between various positions. In a first position, the locking mechanism may engage with the charging connector such that the charging connector 102 is then locked into place within the holster housing 104. Specifically, the charging connector 102 may include a latch 111 with a flange 109 located at the end of the latch 111. When the charging connector 102 is inserted into the holster 103, the flange 109 engages with a protrusion 105 of the holster 103. Normally, the latch 111 is configured to be disengaged from the protrusion 109 such that the charging connector 102 may then be removed from the holster 103 by a user. However, when the locking mechanism 113 is in the first position, a control arm of the locking mechanism 113 (not shown in the figure but shown in more detail in FIGS. 2A-2B, 4A-4B, and 6) may be actuated to a position above the latch 111. This prevents vertical movement of the latch 111 such that the latch 111 is unable to be disengaged from the protrusion 105. Furthermore, in one or more embodiments, the structure of the holster housing 104 and/or structures included within the holster housing 104 (for example, the locking mechanism cover 110) may be provided above the control arm such that the control arm is further prevented from vertical movement while the charging connector 102 is locked in the holster 103. The control arm may be further secured in any other manner as well. FIG. 1C shows another illustration of the example holster 103 and charging connector 102 for an electric vehicle supply equipment (EVSE) in which components other than the locking mechanism 113 and locking mechanism 115 are shaded to emphasize the location of the locking mechanism 113 and locking mechanism 115.

In a second position, the locking mechanism 113 may disengage with the charging connector 102 such that the charging connector 102 may then be removed from the holster housing 104 for use (for example, to be inserted into an electric vehicle to charge the electric vehicle). That is, the control arm of the locking mechanism 113 may again be actuated to a position away from the latch 111. The latch 111 may then be freely disengaged from the protrusion 105 and the charging connector 102 may be removed from the holster 103. Further illustrations of the locking mechanism are provided in at least FIGS. 2A-2B, 4A-4B, and 6. The use of the latch 111 and protrusion 109 is just one example configuration to allow for the charging connector 102 to be locked in the holster 103 and any other suitable mechanisms may also be used as well.

The holster housing 104 may also include one or more masking elements (for example, masking element 108 and masking element 109). A masking element may include any type of opaque material that is provided between a locking mechanism and the holster housing 104. The masking element may prevent visibility of at least a portion of the locking mechanisms from the perspective of a user. Particularly, the masking element may allow for a locking indicator 114 to only be presented when the locking mechanism is in the first position and the charging connector 102 is locked in place within the holster housing 104. For example, FIG. 1B illustrates a scenario where the locking mechanism 113 is in the first position and a locking indicator 114 provided on the locking mechanism 113 is visible adjacent to the masking element 108. In contrast, FIG. 1A illustrates a scenario where the locking mechanism 113 is in the second position and the locking indicator 114 is no longer visible to a user. In this scenario, the locking indicator 114 is positioned behind the masking element 113 as opposed to being positioned adjacent to the masking element 108. Thus, the use of the locking indicator and the masking element allows for a user to make a quick visual determination as to whether a charging connector is locked into the holster 103.

To allow for the locking indicator 114 to transition from a position in which it is visible to a user to a position in which it is no longer visible (or vice versa), the locking indicator 114 may be provided on a control arm of the locking mechanism 113 (shown in more detail in FIGS. 2A-2B). When the locking mechanism 113 is actuated to lock the charging connector 102 into the holster housing 104, the control arm is actuated such that the locking indicator 114 is then made visible (for example, the portion of the control arm including the locking indicator 114 is actuated from a position behind the masking element to a position adjacent to the masking element.)

Although the figure depicts the holster housing 104 as including only two locking mechanisms, this is not intended to be limiting. Any other number of locking mechanisms may also be included depending on the number of charging connectors that the holster housing 104 is configured to receive. Additionally, any reference to a single locking mechanism, masking element, etc. may similarly apply to any other number of locking mechanisms, masking elements, etc. The locking mechanisms are further illustrated and described in additional detail in FIGS. 2A-2B.

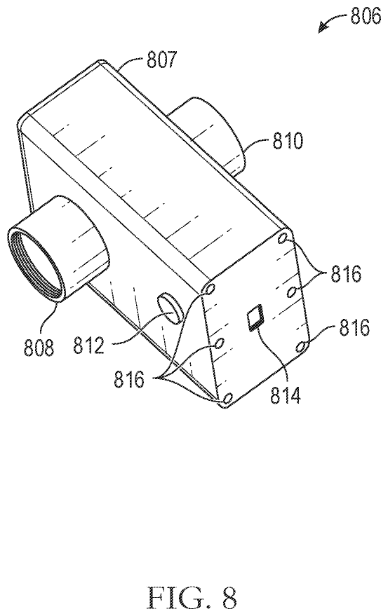

An image capture device 106 may also be provided within the holster housing 104. The image capture device 106 may be a camera, for example, or any other type of device capable of capturing images and/or videos. The image capture device 106 may be positioned within the holster 103 such that a lens of the image capture device 106 is facing the charging connector 102. In this manner, the image capture device 106 may capture images of the charging connector 102 when the charging connector is inserted into the holster 103 when not in use charging an EV. As shown in the figure, the image capture device 106 may also include multiple lenses (for example, lens 120, lens 121, and/or any other number of lenses) facing a number of different directions. This may allow the image capture device 106 to capture images of multiple charging connectors that may be inserted into the holster 103 (the figure only shows the charging connector 102 as being inserted into the holster 103, but the holster 103 may also be configured to receive any other number of charging connectors as well. Although not illustrated in this figure, the image capture device 106 may be mounted to the holster 103 and/or the bulkhead 180. The image capture device 106 may also include a wired or wireless connection(s) with one or more controllers included within a main body of the EVSE (shown in FIG. 12). The wired or wireless connection(s) may allow for power and/or data transfer between the image capture device 106 and the one or more controllers. The image capture device 106 is described in additional detail with respect to FIG. 8.

FIG. 1D shows the latch 111 of the charging connector 102 in accordance with one or more example embodiments of the disclosure. The figure also shows that the latch 111 may be configured to rotate around a pivot 123 (to allow the latch 111 to engage with and disengage from the protrusion 105 of the holster housing 104 (not shown in FIG. 1D). A button 125 may be provided on the charging connector 102 that may be pressed by a user to facilitate the pivoting action of the latch 111. However, the pivoting action may also be performed in any other manner based on the configuration of the particular charging connector. FIG. 1E shows the latch 111 of the charging connector 102 inserted into the holster 103 in accordance with one or more example embodiments of the disclosure.

FIG. 1F shows example charging connector faces including different target icons in accordance with one or more example embodiments of the disclosure. Particularly, the figure illustrates a method by which different charging connectors that are associated with an EVSE may be distinguished. For example, in some embodiments, a holster may be associated with four different charging connectors (this is merely exemplary). The system may need to be able to identify which charging connector is determined to have a physical abnormality so that a technician is able to quickly identify the charging connector that requires maintenance.

The identification method may involve proving an indicator in a target icon 140 that is provided on the face of the charging connector. The figure shows that a “dot” or other type of indicator is provided within one of the four quadrants of the target icon 140. For example, the target icon 142 includes an indicator in a top right-hand quadrant. The target icon 144 includes an indicator in a top left-hand quadrant. The target icon 146 includes an indicator in a bottom left-hand quadrant. The target icon 148 includes an indicator in a bottom right-hand quadrant.

Providing the indicator in the different quadrants may allow for different charging connectors to be identified based on image data captured by the image capture device 106. For example, when a charging connector 102 is inserted into the holster 103, the image capture device 106 may capture an image of a face of the charging connector 102, which may include the target icon.

In some cases, the image data may be provided to the technician (for example, to a mobile device application and/or any other device or system that is accessible by the technician) along with the indication that the charging connector requires maintenance to address an identified physical abnormality. The technician may then be able to visually identify the charging connector that requires the maintenance based on the target icon included in the image. However, a controller (for example, controller 1291 and/or controller 1292) and/or any other system or device may automatically identify the specific charging connector based on the target icon. An indication of the specific charging connector may then be provided to the technician, rather than simply providing the image of the face of the charging connector. For example, the charging connector may be identified based on its position on the holster relative to other charging connectors. As a second example, each charging connector associated with a holster may include a unique identifier that may allow the technician to identify the charging connector even when the charging connector face is inserted into the holster (for example, different charging connectors may be labeled as “1,” “2,” etc.). As a third example, each charging connector may be equipped with a display. This may allow a charging connector to display textual information (or other forms of information) indicating whether that particular charging connector was determined to be associated with a physical abnormality. The indication of the charging connector that requires the maintenance may also be provided in any other manner as well.

This is just one example method by which different charging connectors may be identified and is not intended to be limiting in any way. The charging connectors may also be identified using any other type of visual indicator beyond just the target icon shown in the figure. The charging connectors may also be identified in any other manner as well, including methods that do not necessarily require the use of visual indicators.

FIGS. 2A-2B depict an example locking mechanism 200 for an EVSE in accordance with one or more example embodiments of the disclosure. For example, the locking mechanism 200 shown in the figure may be the same as, or similar to, locking mechanisms 113 and 115, as well as any other locking mechanisms described herein.

In one or more embodiments, the locking mechanism 200 may include at least a control arm 220, a first gear 222 that is engaged with a second gear 224, a motor 226, and a third gear 228 that is also engaged with the second gear 224. The locking mechanism 200 may function to move the control arm 220 between various different positions, including at least a first position (shown in FIG. 2A) and a second position (shown in FIG. 2B).

In the first position, the control arm 220 is actuated to allow the charging connector 102 to be freely inserted into and removed from the holster housing 104. In the first position, the locking indicator 214 is hidden behind the masking element 208 and is not visible to a user. This indicates to the user that the charging connector is not locked within the holster housing 104. That is, a user positioned in front of the EVSE may not be able to view the locking indicator 214 when the control arm 220 is in the first position.

In the second position, the control arm 220 is actuated to prevent the charging connector 102 from being freely inserted into and removed from the holster housing 104. For example, as described with respect to FIGS. 1A-1B, when the locking mechanism 200 is in the second position, the control arm 220 of the locking mechanism 200 may be actuated to a position above the latch (not shown in the figure). This prevents vertical movement of the latch such that the latch is unable to be disengaged from the protrusion (not shown in the figure). In the second position, the locking indicator 214 is adjacent to the masking element 208 and is visible to a user. This indicates to the user that the charging connector is locked within the holster housing 104 and is unable to be removed using physical force.

To actuate the control arm 220 between the first position and the second position, the motor 226 may be driven to rotate a shaft 227 that is coupled to the motor 226. The third gear 228 is provided on the shaft 227 such that the third gear 228 rotates with the rotation of the shaft 228. The third gear 228 may also be engaged with the second gear 224. Likewise, the second gear 224 may be engaged with the first gear 222. The first gear 222 may be coupled to the control arm 220. In this manner, when the motor is driven 226, the third gear 224 rotates, which causes a rotation of the second gear 224, which causes a rotation of the first gear 222, which ultimately causes an actuation of the control arm 220. While reference is made herein to a “first position” and a “second position,” these terms are merely used to exemplify different positions of the control arm and are not intended to be limiting. For example, elsewhere herein, the “first position” may refer to a position in which the locking mechanism is in a “locked position.”

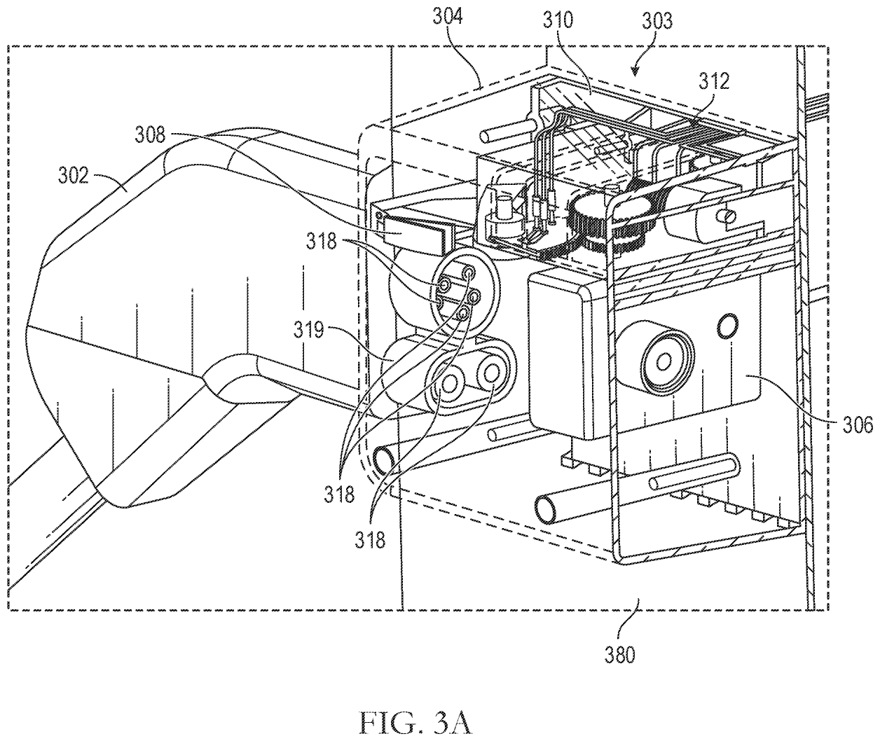

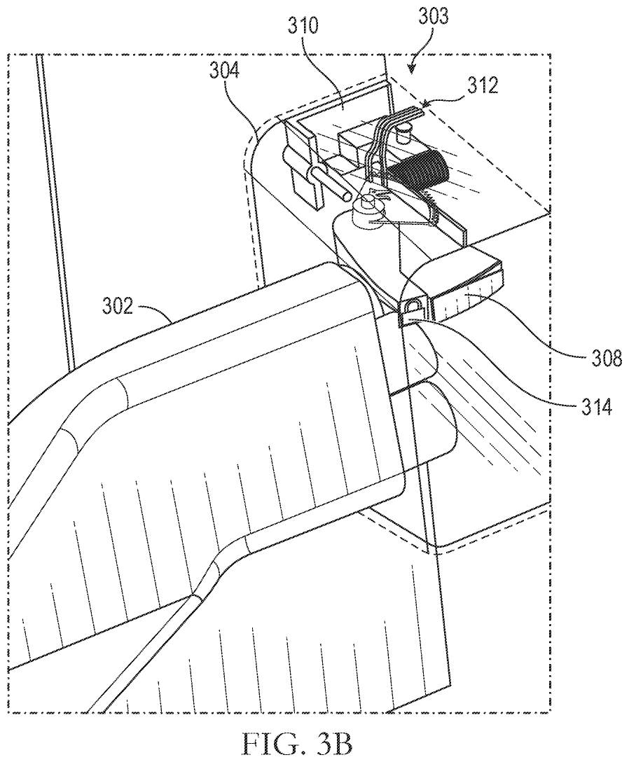

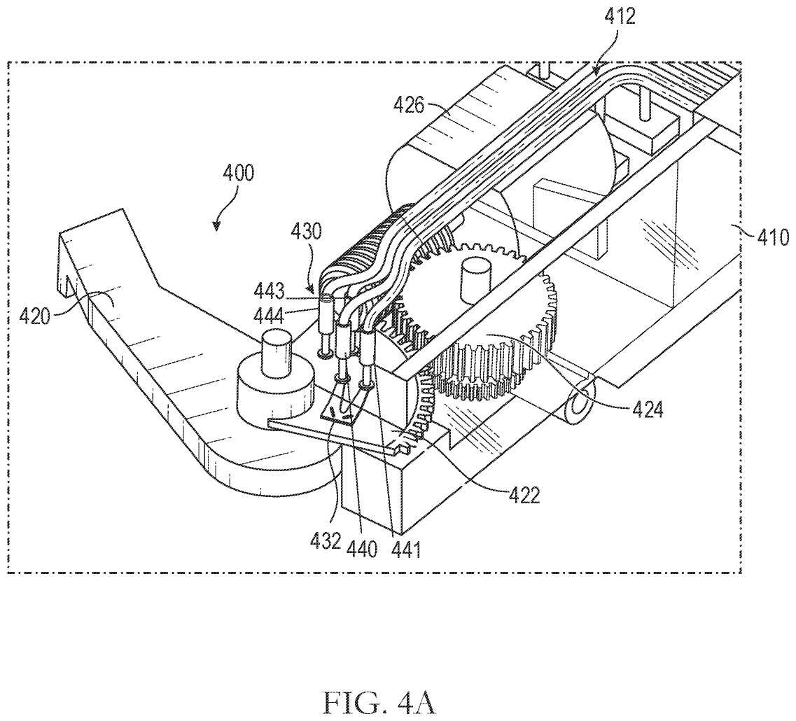

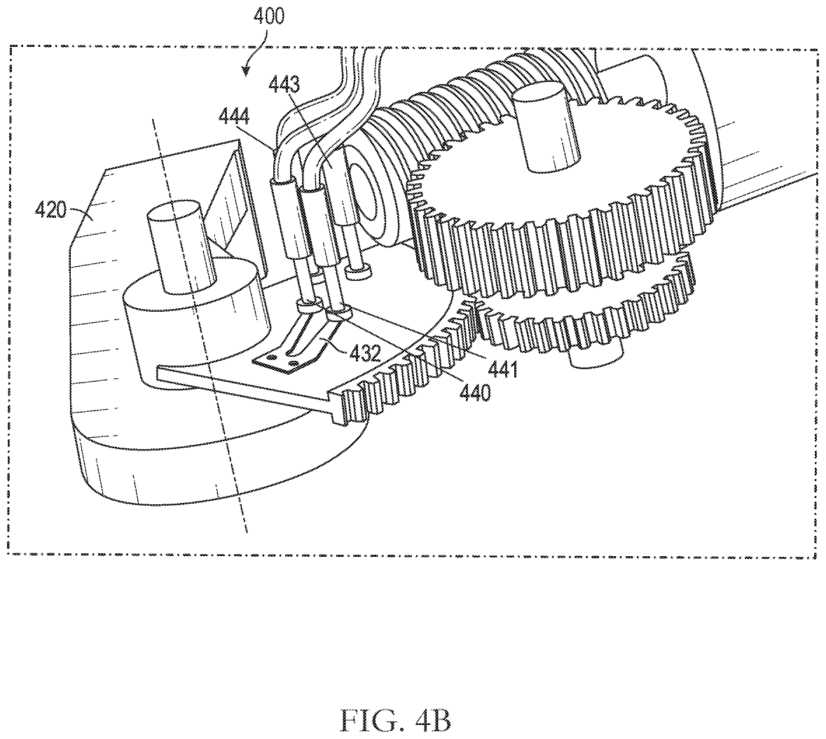

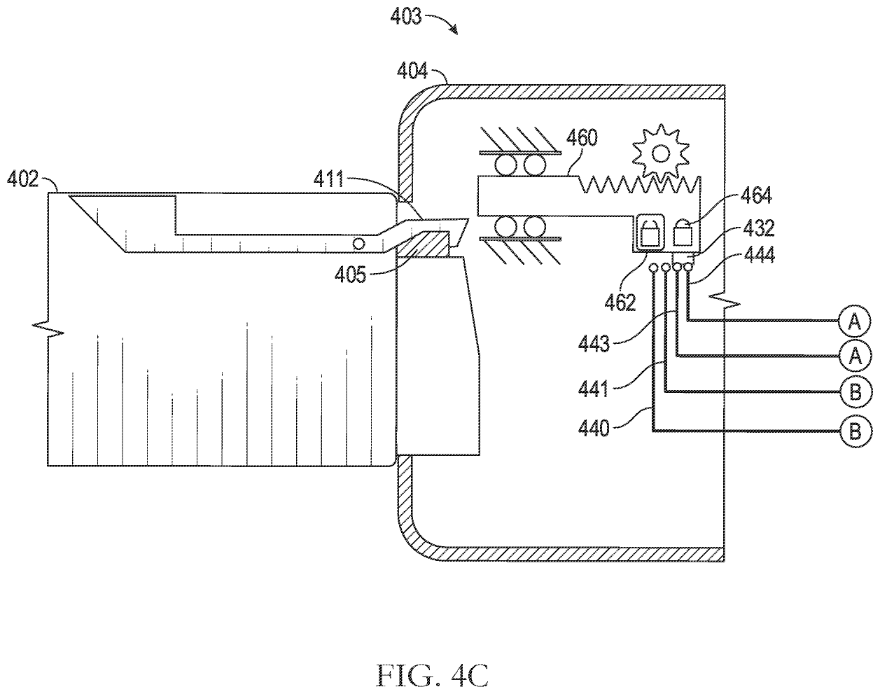

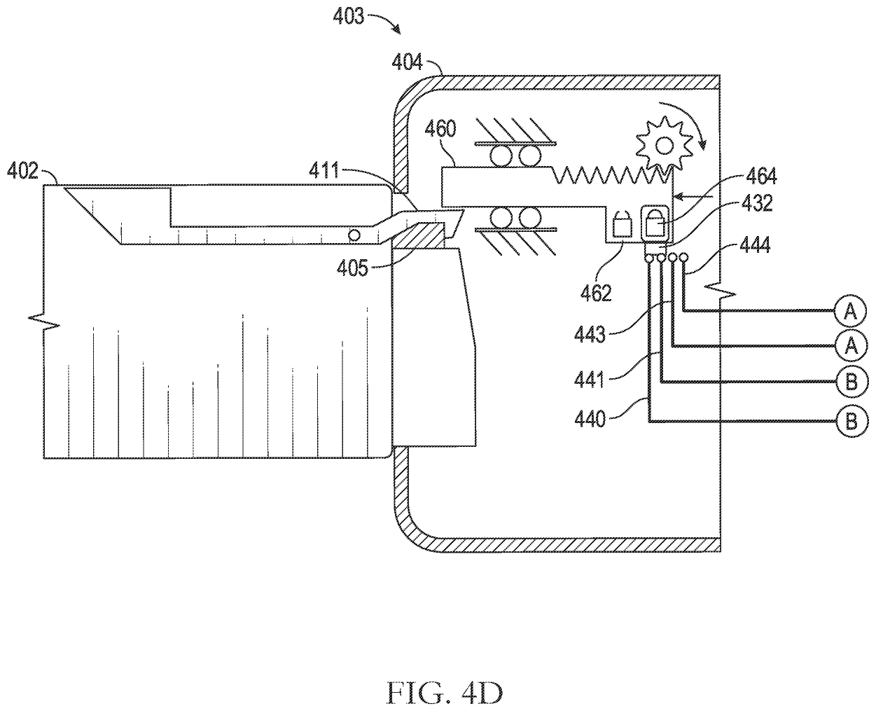

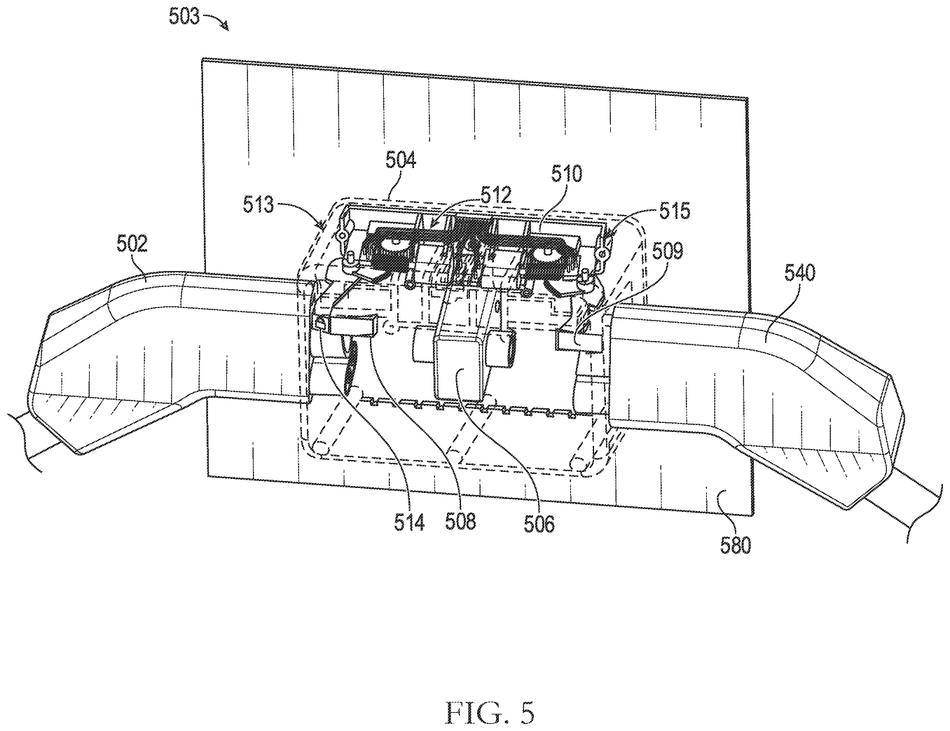

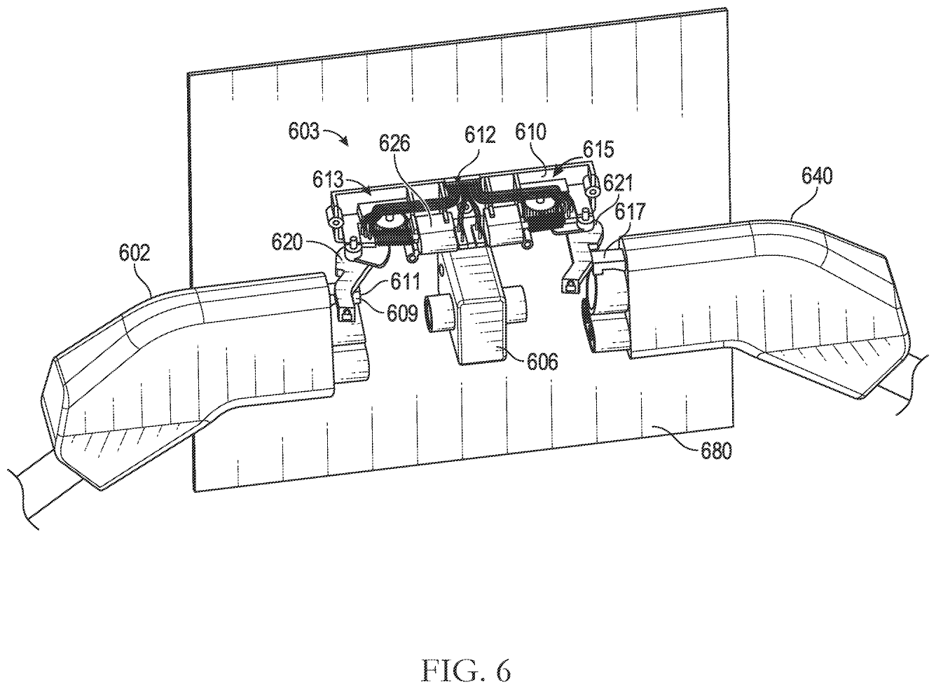

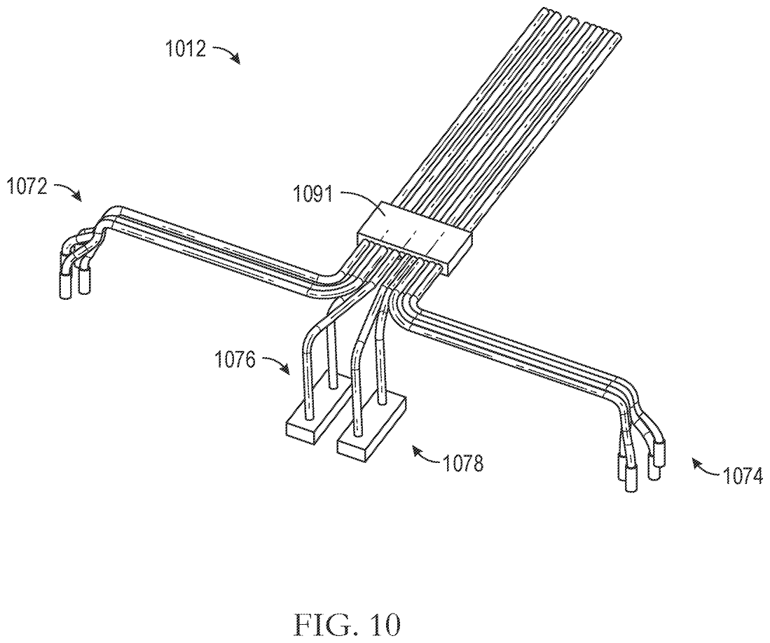

Although not shown in the figure, a wiring harness may provide electrical connection between the motor 226 and one or more controllers (for example, controller 1291 of FIG. 12 and/or any other controller described herein) associated with the EVSE. For example, this wiring harness may be shown as wiring harness 112 of FIGS. 1A-1B, wiring harness 312 of FIGS. 3A-3B, wiring harness 412 of FIGS. 4A-4B, wiring harness 512 of FIG. 5, wiring harness 612 of FIG. 6, wiring harness 1012 of FIG. 10, and/or any other wiring harness described herein or otherwise. Thus, the wiring harness may allow for control signals to be provided to the motor 226 so that the motor 226 can be driven to rotate the shaft 227 and actuate the control arm 220. Additional details about the wiring harness are provided in at least FIG. 10.

FIGS. 3A-3B depict perspective views of an example holster 303 and charging connector 302 for an EVSE in accordance with one or more example embodiments of the disclosure.

Particularly, the perspective view shows that the charging connector 302 may include one or more pins 318. The one or more pins 318 may include conductive elements that facilitate power and/or data transfer between the EVSE and the EV (not shown in the figure). The pins 318 may also include material surrounding the conductive elements, such as a plastic and/or any other type of non-conductive material. The charging connector 302 may also include a casing 319 surrounding the pins 318. The casing 319 may be configured in any number of different shapes depending on the type of charging connector 102. Although the particular arrangement of pins 318 and the casing 319 on the charging connector 302 is indicative of a CCS1 DC charging connector, any other type of charging connector may also be applicable as well.

The pins 318 and casing 319 may serve as the primary portions of the charging connector 302 that may be subject to physical abnormalities identified through images captured by the image capture device 306. For example, a crack may form in the casing 319 and/or any of the pins 318 that may lead to difficulty inserting the charging connector 302 into a plug on the EV. Such a crack may also lead to improper charging of the EV. As another example, debris may be lodged within the casing 319 between any of the pins 318. These are merely examples of physical abnormalities and any other types of physical abnormalities may also exist on the charging connector 302.

FIGS. 4A-4B depict example an example wiring harness 412 positioned on a locking mechanism 400 for an EVSE in accordance with one or more example embodiments of the disclosure.

The wiring harness 412 includes a first set of connectors 430 associated with the locking mechanism and used to track a current position of the control arm 420 of the locking mechanism. To accomplish this position tracking of the control arm 420, a conductive element 432 may be provided on the third gear 422 of the locking mechanism 400 (which may be the same as the third gear 222 shown in FIG. 2). In one or more embodiments, the conductive element 432 may specifically be a copper dual leaf spring that may close an electrical loop including the first set of the connectors 430 when the third gear 422 is in a specific position.

The first set of connectors 430 may include two pairs of connectors (however, any other number of connectors may also be used as well). For example, first connector 440 and second connector 441 may form a first pair of connectors and third connector 443 and fourth connector 444 may form a second pair of connectors. Each pair of connectors may comprise a circuit that is normally open that may be closed when both of the connectors comprising the pair come into contact with the conductive element 432. For example, FIG. 4B shows an instance in which the conductive element 432 is in contact the first pair of connectors, but not the second pair of connectors. In this scenario, a closed circuit may be formed including the first pair of connectors (however, the circuit comprising the second pair of connectors would remain open), which may result in a signal being generated by the first pair of connectors, but not the second pair of connectors.

The first set of connectors 430 may be provided in a fixed position. Consequentially, when the third gear 422 rotates to cause the actuation of the control arm 420, the conductive element 432 follows a fixed path and may come into contact with the first pair of connectors and/or the second pair of connectors based on the current rotational position of the third gear 422. Thus, the position of the locking mechanism may be determined based on the signals (or lack of signals) being received from the respective connector pairs. This is because the conductive element 432 may only be in contact with a particular pair or connectors (or both of the connectors) at certain points in the rotation of the locking mechanism.

This concept is further illustrated in the partial cross-section views of the holster 103 and the charging connector 402 shown in FIGS. 4C-4D. FIG. 4C shows the same concept being applied to an embodiment in which the locking mechanism comprises “rack and pinion” geared sliding dead bolt 460. In this embodiment, the rotation of a gear 455 causes a translation of the dead bolt 460 between an unlocked position (shown in FIG. 4C) and a locked position (shown in FIG. 4D). The conductive element 432 is provided in a fixed position on the dead bolt 460, such that when the dead bolt 460 moves from a first position (shown in FIG. 4C) to a second position (shown in FIG. 4D), the conductive element 432 comes into contact with either the first pair of connectors or the second pair of connectors.

Beginning with FIG. 4C, the dead bolt 460 is shown as being in an unlocked position in which the dead bolt 460 is not located above the latch 411 of the charging connector 402. This allows the latch 411 to be disengaged from the protrusion 405 of the holster housing 404 such that the charging connector 402 may be removed from the holster 403. In this position, the conductive element 432 is in contact with the second pair of connectors (for example, third connector 443 and fourth connector 444). Thus, the circuit comprising the second pair of connectors is closed and a signal is provided from this circuit. Based on this signal, it may be determined that the dead bolt 460 is in the unlocked position.

Turning to FIG. 4D, dead bolt 460 is shown as being in a locked position in which the dead bolt 460 is located above the latch 411 of the charging connector 402. This prevents the latch 411 from being disengaged from the protrusion 405 of the holster housing 404 such that the charging connector 402 may not be removed from the holster 403. In this position, the conductive element 432 is in contact with the first pair of connectors (for example, first connector 440 and second connector 441). Thus, the circuit comprising the first pair of connectors is closed and a signal is provided from this circuit. Based on this signal, it may be determined that the dead bolt 460 is in the locked position.

The figures also illustrate another example embodiment of the locking indicators. For example, instead of including just one locking indicator on a control arm (as shown in FIGS. 1B, 2A-2B, etc.), two different indicators may be provided on the locking mechanism without requiring the use of a mask (the figure shows an unlocked indicator 462 and a locked indicator 464 on the dead bolt 460). Depending on the position of the locking mechanism, either the unlocked indicator 462 or the locked indicator 464 may be illuminated (for example, a light emitting diode (LED) may be provided behind each indicator).

FIGS. 4C-4D merely provide another example of a type of locking mechanism that may be used (and a manner in which the position of the locking mechanism may be determined) and is not intended to be limiting. Any other types of mechanisms used to prevent the latch 411 from being disengaged from the protrusion 405 may also be used as well. Additionally, any other types of locking indicators may also be provided as well. For example, the locking mechanism may include a display screen that may provide any type of indication, such as a textual indication or an image of a lock or unlock icon that may selectively be displayed based on the position of the locking mechanism.

FIG. 5 depicts another example holster 503 for an EVSE in accordance with one or more example embodiments of the disclosure. The figure illustrates that a single holster 503 may be configured to receive more than one charging connector. For example, shown in the figure is a holster 503 that includes two locking mechanisms (locking mechanism 513 and locking mechanism 515) and two charging connectors inserted into the holster 503 (for example, charging connector 502 and charging connector 540). Although the figure only shows a holster 503 that is configured to receive two charging connectors, a holster may also be configured to receive any other number of charging connectors as well.

The holster 503 may also be configured to individually lock and/or unlock any of the charging connectors to the holster 503. For example, the figure illustrates that the locking indicator 514 is visible for the locking mechanism 513 associated with the side of the holster 503 in which the first charging connector 502 is inserted. Thus, the first charging connector 502 is indicated to be locked within the holster 503. However, the locking indicator associated with locking mechanism 515 is not visible, indicating that the second charging connector 540 is not currently locked into place in the holster 503. This selective locking functionality of the holster 503 allows for one charging connector to be locked within the holster 503 while still allowing for the second charging connector 540 to be physically removed from the holster 503 for purposes of charging an electric vehicle. In this manner, even if one charging connector is damaged and locked into the holster 503, the second charging connector is still available for use.

FIG. 6 depicts example internal components of a holster in accordance with one or more example embodiments of the disclosure. That is, the figure shows the holster 603 without the housing that surrounds the internal components of the holster 603. The figure also shows a perspective view that further illustrates a manner in which the locking mechanism locks a charging connector into the holster 603 based on the actuation of a control arm.

Beginning with an example of a locked charging connector 602, the locking mechanism 613 is shown with control arm 620 actuated to a position that prevents removal of the charging connector 602 from the holster 603. As shown in the side view of FIG. 1A, the charging connector 102 includes a tab 111 (shown as tab 611 in FIG. 6). When the charging connector 602 is inserted into the holster 603, a flange (shown as flange 109 in FIG. 1A and flange 609 in FIG. 6) of the tab 611 engages with a protrusion (shown as protrusion 105 in FIG. 1A but not shown in FIG. 6) included in the holster 603. With the locking mechanism 613 in a locked position, the control arm 620 is positioned above the tab 611. In this manner, the tab 611 is unable to disengage from the protrusion and the charging connector 602 is forced to remain locked within the holster 603.

Turning to an example of an unlocked charging connector 640, the locking mechanism 615 is shown with control arm 621 actuated to a position that allows for removal of the charging connector 640 from the holster 603. This is because in the unlocked position the control arm 621 is actuated away from the tab 617 of the charging connector 640. Thus, when a user exerts a force to pull the charging connector 640 out of the holster 603, the tab 617 is able to freely disengage from the protrusion (not shown in the figure) and be removed from the holster 603. To unlock the charging connector 602 from the holster 603, the control arm 620 may be actuated to a position in which the control arm 620 is not directly above the tab 611. As mentioned herein, this actuated may be performed by providing a control signal to motor 626 through the wiring harness 612, which may be connected to one or more controllers. Likewise, to lock the charging connector 640 in the holster 603, the control arm 621 may be actuated to a position in which the control arm 621 is directly above the tab 617.

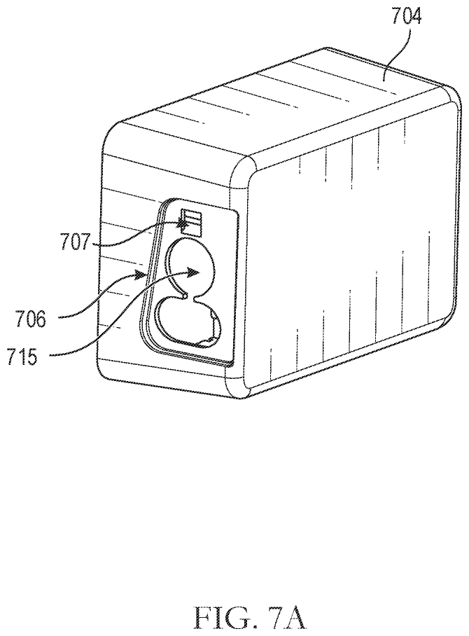

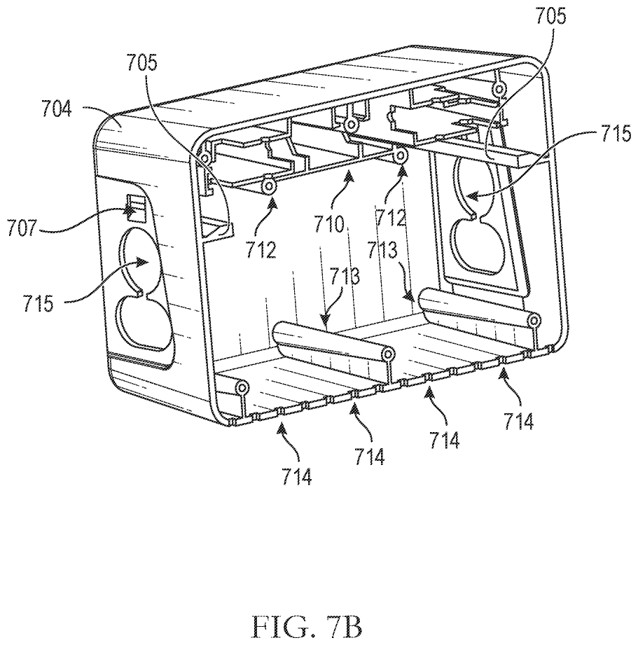

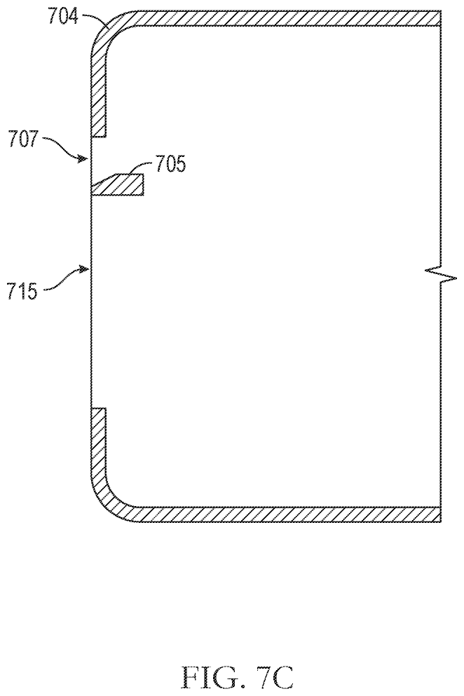

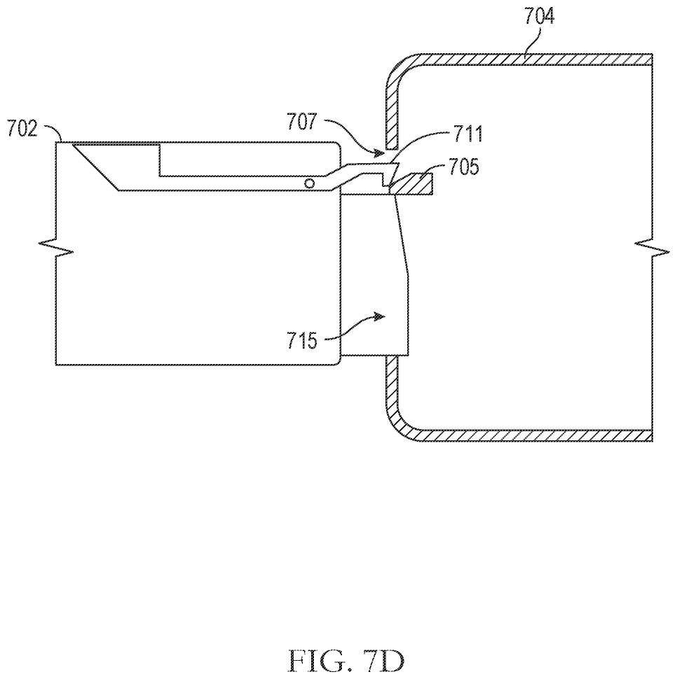

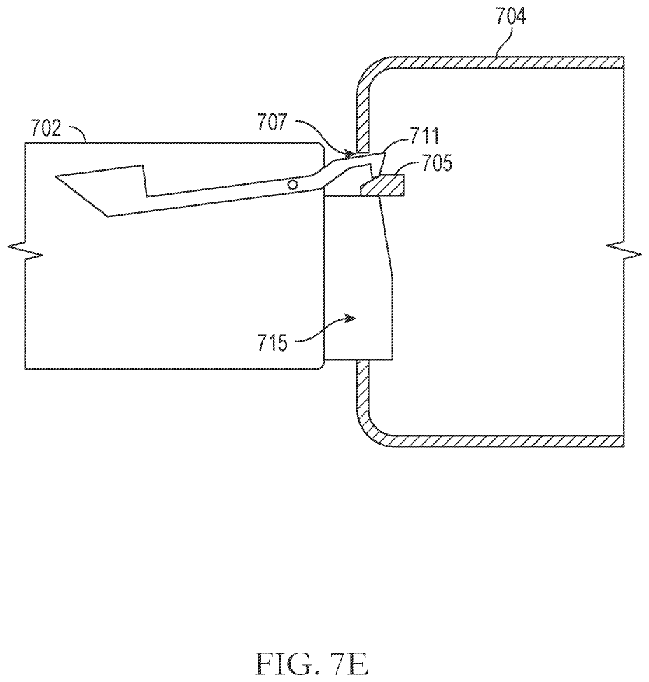

FIGS. 7A-7B depicts an example holster housing 704 for an EVSE in accordance with one or more example embodiments of the disclosure.

FIG. 7A illustrates an example exterior view of the holster housing 704. The holster housing 704 may include any number of different types of materials (for example, metals, plastics, etc.). The holster housing 704 may be configured such that the holster housing 704 is resistant to environmental conditions and protects any internal components from environmental conditions as well. This is important because the EVSE may be provided in an outdoor environment that may be subject to conditions such as weather conditions, etc. The holster housing 704 may also include one or more first apertures 715 through which a charging connector (not shown in the figure) may be inserted. The holster housing 704 may further include a second aperture 707 through which the tab (for example, tab 111) of the charging connector may be inserted. Although the figure only illustrates one aperture for receiving a single charging connection, the holster housing 704 may similarly include any other number of apertures used to receive any other number of charging connectors. The holster housing 704 may also include a recess 706 that is used to prevent rain run-off from entering the interior of the holster housing 704. Although the holster housing 704 illustrated in the figure includes flat surfaces, any of the surfaces may also be provided at an angle to enhance water run-off.

FIG. 7B illustrates an example interior of the holster housing 704. In one or more embodiments, the interior may include a locking mechanism cover 710, one or more protrusions 705, one or more screw bosses (for example, first screw bosses 712, second screw bosses 713, and/or any other screw bosses), and one or more holster housing apertures 714. It should be noted that the particular configuration of the interior of the holster housing 704 is merely exemplary and is not intended to be limiting in any way. Some of these components illustrated in FIG. 7B are further illustrated in the partial cross-section shown in FIG. 7C as well.

The locking mechanism cover 710 may be a structure that is provided within the holster housing 704 that is configured to receive various components of the locking mechanisms. For example, the locking mechanism cover 710 may include various cut-outs to receive such components. The locking mechanism cover 710 may also include the first screw bosses 712. The first screw bosses 712 may be configured to receive one or more fasteners (for example, screws, etc.) such that the locking mechanism cover 710 may be secured to an interior surface of the holster housing 704 as a sub-assembly. However, the locking mechanism cover 710 may simply be provided as a permanent structure within the holster housing 704 as well. The cut-outs, first screw bosses 712 and other additional details about the locking mechanism cover 710 are provided with respect to the locking mechanism 910 of FIG. 9.

The one or more protrusions 705 (which may be the same as protrusion 105) may be structures within the holster housing 704 that may be configured to engage with a latch of a charging connector (for example, latch 111 shown in FIGS. 1A-1B that includes a flange 109 located at the end of the latch). When the charging connector 12 is inserted into the holster, the flange engages with a protrusion 705 of the holster.

The second screw bosses 713 may be provided on the holster housing 704. The second screw bosses 713 may also be configured to receive one or more fasteners (for example, screws, etc.) such that the holster housing 704 may be secured to the bulkhead (not shown in the figure) of the EVSE as a sub-assembly. However, the holster housing 704 may simply be provided as a permanent structure of the EVSE as well.

The one or more holster housing apertures 714 may be provided at various portions of the holster housing 704 to provide drainage of any water that enters the interior of the holster housing 704.

FIGS. 7D-7E depict partial cross-section views of an example holster housing 704 showing an engagement of a charging connector latch 711 with the holster housing 704 in accordance with one or more example embodiments of the disclosure.

Beginning with FIG. 7D, the holster housing 704 of FIGS. 7A-7C is shown with the addition of a partial cross-section view of a charging connector 702. The charging connector 702 is shown as being inserted into the holster housing 704, with the latch 711 being inserted into the second aperture 707. The progression of the insertion of the latch 711 is continued in FIG. 7E, which shows the latch 711 rotating up to ride over the protrusion 705 to ultimately engage with the protrusion 705 (this is shown in FIG. 1E, for example).

FIG. 8 depicts an example image capture device 806 for an EVSE in accordance with one or more example embodiments of the disclosure.

In one or more embodiments, the image capture device 806 may include any suitable device (for example, a camera and/or any other type of device) configured to capture images of a charging connector when the charging connector is inserted into a holster. The image capture device 806 may include a housing 807, one or more lenses (for example, first lens 808, second lens 810, and/or any other number of lenses), one or more illumination sources (for example, illumination source 812 and/or any other number of illumination sources, and one or more data and/or power connectors 814.

In one or more embodiments, the one or more lenses may be capable of providing high-resolution image of a face of a connector. In this manner, the image may be analyzed to identify any physical abnormalities associated with the charger connector. A first example of a physical abnormality may include a crack on a portion of the charger connector. A second example of a physical abnormality may include debris that is lodged within the charging connector. A third example of a physical abnormality may include a bent conductor in the charging connector. These are merely illustrative examples of types of physical abnormalities that may be identified and are not intended to be limiting.

The image capture device 806 may include any number of lenses depending on the number of charging connectors that the particular holster is configured to receive. For example, the image capture device 806 shown in the figure includes two lenses (lens 808 and lens 810). Thus, this particular image capture device 806 is configured to be included in a holster configured to receive two charging connectors. The first lens 808 may be pointed in the direction of the aperture through which a first charging connector is inserted, such that the image capture device 806 may then capture images of that first charging connector using the lens 808. The second lens 810 may be pointed in the direction of the aperture through which a second charging connector is inserted, such that the image capture device 806 may then capture images of that second charging connector using the lens 810.

The one or more illumination source(s) 812 may be configured to provide illumination within the holster to allow for clearer image capture to be performed. The illumination source(s) 812 may be configured to operate using any number of different wavelengths of light. For example, the illumination source(s) 812 may illuminate visible light, infra-red light, and/or any other wavelengths of light. As one non-limiting example, an illumination source may include an infra-red light-emitting diode (IR LED). An image capture device 806 may also include multiple different illumination sources each configured to illuminate light at different wavelengths and/or may be configured to illuminate varying wavelengths of light from a single illumination source as well. In some examples, illumination source(s) 812 could include a projector such that images captured via lenses 808 or 810 can be analyzed for depth information. In some examples, depth information is obtained in other ways, such as using a stereo image capture system.

The one or more data and/or power connectors 814 may be provided to receive a cable used to provide power to the image capture device 806. In some embodiments, the image capture device 806 may also be provided power wirelessly, such as through inductive coupling or any other wireless power transmissions methods. The one or more data and/or power connectors 814 may also allow for data transmissions to and from the image capture device 806. For example, the image capture device 806 may transmit any captured images to a local or remote system for processing (for example, the controller 1292 of FIG. 12). The image capture device 806 may also receive signals, such as signals to perform one or more image captures. However, this logic may also be stored locally on the image capture device 806 as well.

Similar to the holster housing 704 described in FIG. 7A, the outer case and any lenses of the image capture device 806 may be configured to prevent external conditions from impacting internal components of the image capture device 806. The housing 704 may also include one or more apertures 816. The one or more apertures 816 may be configured to receive fasteners (for example, threaded screws) to allow the image capture device 806 to be secured to the holster housing and/or the bulkhead (not shown in the figure) of the EVSE. However, the image capture device 806 may also be removeably mounted to the holster housing and/or the bulkhead using any other method. A rubber gasket or similar material may also be used at this interface.

FIG. 9 depicts an example locking mechanism cover 910 in accordance with one or more example embodiments of the disclosure. The locking mechanism cover 910 may be the same as locking mechanism cover 110 shown in FIGS. 1A-1B, locking mechanism cover 310 shown in FIGS. 3A-3B, locking mechanism cover 410 shown in FIGS. 4A-4B, locking mechanism cover 510 shown in FIG. 5, locking mechanism cover 610 shown in FIG. 6, locking mechanism cover 710 of FIG. 7 and/or any other locking mechanism cover described herein or otherwise. The locking mechanism cover 910 may be a component that is provided in a holster to support any locking mechanisms (and/or any other components) included in the holster. In some instances, the locking mechanism cover 910 may be mounted to one or more interior surfaces of the holster housing. However, the locking mechanism cover 910 may also be mounted to any other surface and/or components of the holster, the bulkhead, or otherwise.

In one or more embodiments, the locking mechanism cover 910 may include at least one or more cut-outs (for example, first cut-outs 914 second cut-outs 916, third cut-outs 920, fourth cut-outs 922, and/or any other number of cut-outs), one or more screw bosses (for example, screw-bosses 918, screw bosses 924, and/or any other screw bosses), and/or one or more apertures (for example, one or more apertures 912 and/or any other apertures). The one or more apertures 912 may be apertures used to receive the first set of connectors 430 shown in FIGS. 4A-4B.

The one or more cut-outs may be provided to receive various components of the locking mechanisms and/or any other components included within the holster. For example, the first cut-outs 914 may be provided to receive a control arm pivot. The second cut-outs 916 may be provided to receive an intermediate gear drive pivot. The third cut-outs 920 may be provided to receive one or more motors (for example, motor 226 and/or any other motor described herein) associated with a locking mechanism. The fourth cut-outs 922 may be provided to receive any shafts (for example, shaft 227 and/or any other shaft described herein) connected to the motors used to drive the locking mechanism.

The one or more screw-bosses may be provided on the locking mechanism cover 910 to receive fasteners to secure the locking mechanism cover 910 to the holster, the bulkhead, and/or any other structure described herein or otherwise. However, the locking mechanism cover 910 may also be removeably secured to the holster the bulkhead, and/or any other structure through any other suitable method.

FIG. 10 depicts an example wiring harness 1012 in accordance with one or more example embodiments of the disclosure. For example, this wiring harness may be representative of wiring harness 112 of FIGS. 1A-1B, wiring harness 312 of FIGS. 3A-3B, wiring harness 412 of FIGS. 4A-4B, wiring harness 512 of FIG. 5, wiring harness 612 of FIG. 6, and/or any other wiring harness described herein or otherwise.

The wiring harness 1012 may be connected to one or more controllers (not shown in the figure), which may be the same as controller 1291, controller 1292 of FIG. 12 and/or any other controller described herein or otherwise. The wiring harness 1012 may also be connected to multiple controllers as well. In this manner, the controller may be able to transmit and/or receive signals and/or power to and from any components included within the holster.

The wiring harness 1012 may also include one or more connectors that may be connected to various portions of the internal components of the holster. For example, the wiring harness 1012 may include at least a first set of connectors 1072, a second set of connectors 1074, a third set of connectors 1076, and/or a fourth set of connectors 1078. The wiring harness 1012 may also include any other number of connectors. Additionally, while the figure may depict a particular set of connectors as including a specific number of individuals connectors, this is not intended to be limiting. For example, the figure shows the first set of connectors 1072 as including four individual connectors, however, the first set of connectors 1072 may also include any other number of individual connectors as well.

The first set of connectors 1072 and the second set of connectors 1074 may be associated with two locking mechanisms included within the holster housing. For example the wiring harness 1012 may be the same wiring harness 112 that is included within the holster 103 that includes two locking mechanisms associated with two separate charging connectors. Thus, the first set of connectors 1072 may be associated with the locking mechanism 113 associated with a first charging connector and the second set of connectors 1074 may be associated with the locking mechanism 115 associated with a second charging connector. However, this is merely exemplary and the wiring harness 1012 may similarly including any other number of different sets of connectors that may be associated with any other number of locking mechanisms depending on the configuration of the particular holster.

As shown in FIGS. 4A-4B, the first set of connectors 1072 may be used to determine a current position of a control arm associated with the first locking mechanism and the second set of connectors 1074 may be used to determine a current position of the control arm associated with the second locking mechanism (for example, as described with respect to FIGS. 4A-4D).

The third set of connectors 1076 and the fourth set of connectors 1078 may be connected to the motors (for example, motor 226 of FIGS. 2A-2B) used to actuate the locking mechanisms (for example, the third set of connectors 1076 may be used to provide a signal to drive a first motor to actuate a control arm of a first locking mechanism and the fourth set of connectors 1078 may be used to provide a signal to drive a second motor to actuate a control arm of a second locking mechanism. As with the first set of connectors 1072 and the second set of connectors 1074, there may exist any other number of connectors used to connect any motors of the locking mechanisms to the controller.

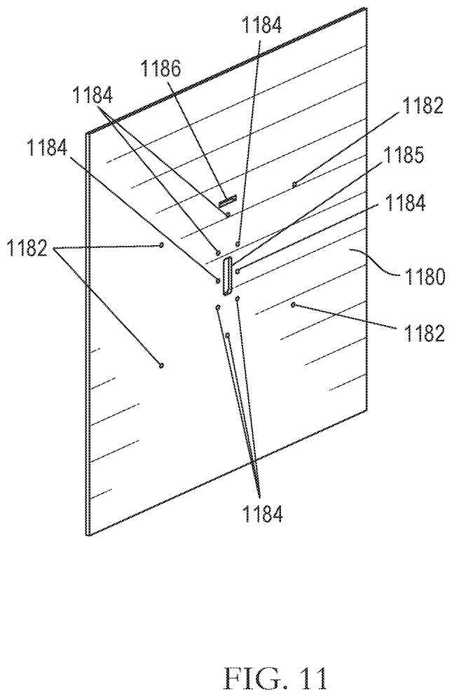

FIG. 11 depicts an example bulkhead 1180 in accordance with one or more example embodiments of the disclosure. The bulkhead 1180 may be the same as bulkhead 180 shown in FIGS. 1A-1B, bulkhead 380 shown in FIGS. 3A-3B, bulkhead 580 shown in FIG. 5, bulkhead 680 shown in FIG. 6, and/or any other bulkhead described and/or depicted herein.

The bulkhead 1180 may be a portion of the EVSE to which the holster (not shown in the figure) is mounted. The bulkhead 1180 may include one or more apertures used for various purposes. For example, the bulkhead 1180 may include a first set of apertures 1182, a second set of apertures 1184, a third aperture 1185, a fourth aperture 1186, and/or any other number of apertures.

The first set of apertures 1182 may include through-holes configured to receive fasteners for mounting the holster to the bulkhead 1180. The second set of apertures 1184 may include through-holes configured to receive fasteners for mounting the image processing device to the bulkhead 1180. The third aperture 1185 may be a through-hole configured to allow any electrical connections between the internal components of the holster and the controller located behind the bulkhead 1180 within the EVSE to pass through the bulkhead 1180. For example, these electrical connections may include at least power and data connections for the image processing device and/or any other electrical connections. The fourth aperture 1186 may be a through-hole configured to allow the wiring harness associated with any locking mechanisms included within the holster to pass through the bulkhead 1180 (for example, wiring harness 1012 shown in FIG. 10).

It should be noted that while the figure illustrates a specific number of apertures and a specific arrangement of apertures on the bulkhead 1180, this is not intended to be limiting in any way. Any of the apertures may be provided at any other position on the bulkhead 1180. Additionally, any other number of apertures may also be used as well. As a first example, the first set of apertures 1182 may include fewer than or greater than six apertures. As a second example, a single aperture may be used for routing all electrical connections through the bulkhead 1180 rather than using the separate third aperture 1184 and fourth aperture 1186.

FIG. 12 depicts an example EVSE system 1200 in accordance with one or more example embodiments of the disclosure. In one or more embodiments, the EVSE system 1200 may include a holster 1203 (which may be the same as holster 103 and/or any other holster described herein), which may be mounted to a bulkhead 1281 (which may be the same as bulkhead 1180 and/or any other bulkhead described herein) that separates a main body 1280 of the EVSE system 1200 from the holster 1203.

The main body 1280 may include any processing components and power supply components of the EVSE system 1200. For example, the main body 1280 may include at least a first controller 1291 and a second controller 1292. In one or more embodiments, the main body 1280 may only include one controller that may be used to perform all of the processing that would otherwise be performed separately by the first controller 1291 and the second controller 1292. The main body 1280 may also include any other number of controllers as well. Additionally, any of the controllers may include any of the elements of the computing device 1400, such as one or more processors, memory, etc. Furthermore, while the first controller 1291 and the second controller 1292 are shown as being provided within the main body 1280, the first controller 1291 and/or the second controller 1292 (and/or any other controller or element shown as being included in the main body 1280) may similarly be provided in the holster 1203 as well. Any of the controllers may also be provided at any other location, such as externally to the EVSE system 1200.

In one or more embodiments, the first controller 1291 may be configured to perform functions associated with the locking mechanism 1213. The first controller 1291 may receive one or more inputs, including at least a first signal 1250, a second signal 1251, and/or a third signal 1252 (as well as any other number of inputs).

In one or more embodiments, the first signal 1250 may be a signal indicating a position of a control arm 1220 of the locking mechanism 1213. For example, the first signal 1250 may be a signal that is produced by the first set of connectors 1072 and/or the second set of connectors 1074 associated with the wiring harness 1012 shown in FIG. 10. The first signal 1250 may be used by the controller 1291 to determine if a physical abnormality has been identified for a charging connector 1202. For example, if a signal is received indicating that the control arm 1220 is in a locked position, then the first controller 1291 may determine that there is a physical abnormality associated with the charging connector 1202. However, as described below, such determinations may instead be made based on image data provided by the image capture device 1206 to the second controller 1292. In some embodiments, this determination may be made based on a combination of the first signal 1250 and the image data.

The first signal 1250 may also be used for other purposes, such as troubleshooting purposes. For example, the first signal 1250 may be used for troubleshooting purposes to identify instances in which there is a fault in the locking mechanism 1213 (for example, to determine if the locking mechanism is not properly locking and/or unlocking). The first signal 1250 may also be used for any other purposes as well.

The second signal 1251 may be a signal from the second controller 1292 indicating that a physical abnormality was identified with the charging connector 1202. For example, the second controller 1292 may output the second signal 1251 to the first controller 1291 as a result of identifying a physical abnormality associated with the charging connector 1202 based image data captured by the image capture device 1206 (however, as aforementioned, a single controller may be used in place of the combination of the first controller 1291 and the second controller 1292 as well). Based on receiving the second signal 1251, the first controller 1291 may output a fourth signal 1253. The fourth signal 1253 may be a signal that causes the motor (not shown in the figure) of the locking mechanism 1213 to actuate the control arm 1220 between two positions. Specifically, the fourth signal 1253 may be transmitted to the motor to cause the motor to actuate the control arm 1220 from a position in which the charging connector 1202 is able to be removed from the holster 1203 to a position in which the charging connector 1202 is locked within the holster 1203. That is, the control arm 1220 is actuated to lock the charging connector 1202 in place and prevent the charging connector 1202 from being removed until maintenance is performed.

The third signal 1252 may be a signal indicating that maintenance of the charging connector 1202 has been completed. The third signal 1252 may be received from an external system 1293. For example, the external system 1293 may include a remote server, device, etc. In one or more embodiments, the external system 1293 may be operated by a user. The user may be a technician (or any other user) that performs maintenance on the charging connector and then provides an indication that the maintenance has been performed through the external system 1293. Upon receiving the third signal 1252, the first controller 1291 may output a fifth signal 1254 to the motor of the locking mechanism 1213. The fifth signal 1254 may be a signal that causes the motor of the locking mechanism 1213 to actuate the control arm 1220 from a position in which the charging connector 1202 is locked in the holster 1203 to a position in which the charging connector 1202 is able to be freely removed from the holster 1203. The locking mechanism 1213 may also actuate the control arm 1220 to the unlocked position based on any other number of conditions. For example, based on a determination that the technician (or a mobile device associated with the technician, such as a smartphone and/or any other type of device) is located at the EVSE to perform maintenance on the charging connector 1202. As a second example, the control arm 1220 may be actuated to the unlocked position based on an unlock signal being received from an authorized device. For example, a technician may provide an input to an application of a mobile device, where the input causes the control arm 1220 to actuate, unlocking the charging connector from the holster. These are merely two additional examples and are not intended to be limiting.

The first controller 1291 may also be configured to output a sixth signal 1255 when it is determined that the locking mechanism 1213 is experiencing a fault condition. For example, the sixth signal 1255 may be output to the external system 1293. The user (for example, technician or any other user) may be able to view an indication that the locking mechanism 1213 is experiencing the fault condition (for example, the locking mechanism 1213 is improperly functioning and is unable to actuate between a locking position and an unlocked position). The user may then travel to the location of the EVSE to perform maintenance on the locking mechanism 1213.

The second controller 1292 may be configured to perform functions associated with the image capture device 1206. For example, the second controller 1292 may generally be configured to provide power and control signals to the image capture device 1206. The second controller 1292 may also be configured to receive images from the image capture device 1206 and analyze the received images to identify physical abnormalities associated with the charging connector 1202. This image analysis may be performed using any suitable image processing techniques. In some instances, the image analysis may be performed using an artificial intelligence model, machine learning model, or the like.

Specifically, the second controller 1202 may receive a seventh signal 1256 and output an eighth signal 1257, a ninth signal 1258, and a tenth signal 1259. The seventh signal 1256 may be power that is provided to the image capture device 1206. The eighth signal 1257 may be image data that is received from the image processing device 1206. For example, the image data may include images captured by the image capture device 1206 of the charging connector 1202. The tenth signal 1259 may be an alarm signal that is provided to an alarm component of the EVSE system 1200. For example, the EVSE may include one or more speakers 1294 that may emit an audible alert indicating that a physical abnormality was detected with a charging connector. An audible alert may also be emitted based on any other conditions as well, such as improper use of a charging connector or failure to return the charging connector back to the holster 1203 after use. The EVSE system 1200 may also provide any alert in any other form as well (for example, a visible alert, a tactile alert, and/or any other type of alert).

The holster 1203 may be the portion of the EVSE that is used to receive the charging connector 1202 when the charging connector 1202 is not in use and charging an electric vehicle. The charging connector 1202 may include a cable 1240 that connects the charging connector 1202 to a power source within the main body 1280 of the EVSE system 1200. The holster 1203 may include at least the locking mechanism 1213 and the image capture device 1206. The holster 1203 may also be configured to receive one or more charging connectors 1202. The holster 1203 may also include any other components described as being associated with any of the holsters described herein or otherwise. Additionally, in some embodiments, some or all of the components (or portions of the components) shown as being included in the holster 1203 may also be included in the main body 1280 of the EVSE system 1200 as well.

FIG. 13 depicts an example process flow 1300 in accordance with one or more example embodiments of the disclosure.

At block 1302 of the process flow 1300, computer-executable instructions stored on a memory of a device, such as controller 1291, controller 1292, computing device 1400 and/or any other device, may be executed to receive identify, based on first image data received from AN image capture device, a physical abnormality associated with A first charging connector, wherein the image capture device and the first charging connector are associated with an electric vehicle supply equipment (EVSE) holster. At block 1304 of the processor flow, computer-executable instructions stored on a memory of a device may be executed to cause to send, based on identifying the physical abnormality, a first signal to actuate a first locking mechanism of the EVSE holster from a first position to a second position, wherein the first locking mechanism prevents the first charging connector from being removed from the EVSE holster while in the second position. At block 1306 of the processor flow, computer-executable instructions stored on a memory of a device may be executed to determine, based on second image data received from the image capture device, that the physical abnormality is no longer present. At block 1308 of the processor flow, computer-executable instructions stored on a memory of a device may be executed to cause to cause to send, based on the determination that the physical abnormality is no longer present, a second signal to actuate the first locking mechanism from the second position to the first position, wherein the first locking mechanism prevents the first charging connector from being removed from the EVSE holster while in the first position

One or more operations of the methods, process flows, or use cases of FIGS. 1-12 may have been described above as being performed by a user device, or more specifically, by one or more program module(s), applications, or the like executing on a device. It should be appreciated, however, that any of the operations of the methods, process flows, or use cases of FIGS. 1-12 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-12 may be described in the context of the illustrative devices, it should be appreciated that such operations may be implemented in connection with numerous other device configurations.

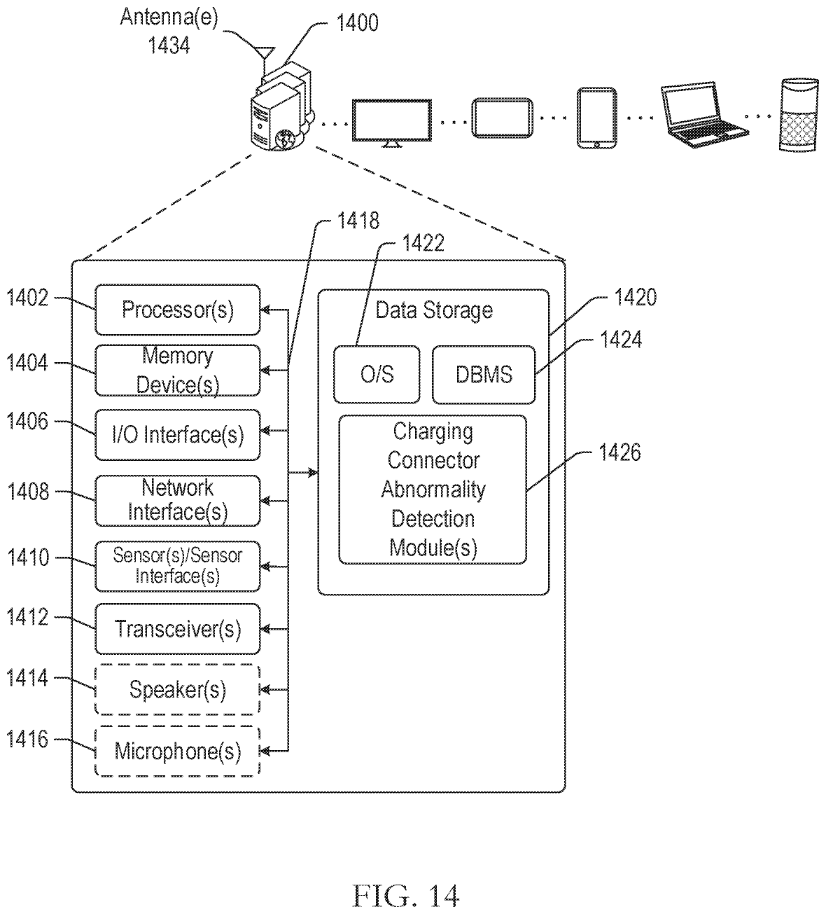

FIG. 14 is a schematic block diagram of an illustrative computing device 1400 in accordance with one or more example embodiments of the disclosure. The computing device 1400 may include any suitable computing device capable of receiving and/or generating data including, but not limited to, a mobile device such as a smartphone, tablet, e-reader, wearable device, or the like; a desktop computer; a laptop computer; a content streaming device; a set-top box; or the like. The computing device 1400 may correspond to an illustrative device configuration for the devices of FIGS. 1-13.

The computing device 1400 may be configured to communicate via one or more networks with one or more servers, search engines, user devices, or the like. In some embodiments, a single remote server or single group of remote servers may be configured to perform more than one type of content rating and/or machine learning functionality.

Example network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 1400 may include one or more processors (processor(s)) 1402, one or more memory devices 1404 (generically referred to herein as memory 1404), one or more input/output (I/O) interface(s) 1406, one or more network interface(s) 1408, one or more sensors or sensor interface(s) 1410, one or more transceivers 1412, one or more optional speakers 1414, one or more optional microphones 1416, and data storage 1420. The computing device 1400 may further include one or more buses 1418 that functionally couple various components of the computing device 1400. The computing device 1400 may further include one or more antenna(e) 1434 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 1418 may include at least one of a system bus, a memory bus, an address bus, or a message bus, and may permit exchange of information (e.g., data (including computer-executable code), signaling, etc.) between various components of the computing device 1400. The bus(es) 1418 may include, without limitation, a memory bus or a memory controller, a peripheral bus, an accelerated graphics port, and so forth. The bus(es) 1418 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 1404 of the computing device 1400 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 1404 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 1404 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 1420 may include removable storage and/or non-removable storage including, but not limited to, magnetic storage, optical disk storage, and/or tape storage. The data storage 1420 may provide non-volatile storage of computer-executable instructions and other data. The memory 1404 and the data storage 1420, removable and/or non-removable, are examples of computer-readable storage media (CRSM) as that term is used herein.

The data storage 1420 may store computer-executable code, instructions, or the like that may be loadable into the memory 1404 and executable by the processor(s) 1402 to cause the processor(s) 1402 to perform or initiate various operations. The data storage 1420 may additionally store data that may be copied to memory 1404 for use by the processor(s) 1402 during the execution of the computer-executable instructions. Moreover, output data generated as a result of execution of the computer-executable instructions by the processor(s) 1402 may be stored initially in memory 1404, and may ultimately be copied to data storage 1420 for non-volatile storage.

More specifically, the data storage 1420 may store one or more operating systems (O/S) 1422; one or more database management systems (DBMS) 1424; and one or more program module(s), applications, engines, computer-executable code, scripts, or the like such as, for example, one or more charging connector abnormality detection module(s) 1426. Some or all of these module(s) may be sub-module(s). Any of the components depicted as being stored in data storage 1420 may include any combination of software, firmware, and/or hardware. The software and/or firmware may include computer-executable code, instructions, or the like that may be loaded into the memory 1404 for execution by one or more of the processor(s) 1402. Any of the components depicted as being stored in data storage 1420 may support functionality described in reference to correspondingly named components earlier in this disclosure.

The data storage 1420 may further store various types of data utilized by components of the computing device 1400. Any data stored in the data storage 1420 may be loaded into the memory 1404 for use by the processor(s) 1402 in executing computer-executable code. In addition, any data depicted as being stored in the data storage 1420 may potentially be stored in one or more datastore(s) and may be accessed via the DBMS 1424 and loaded in the memory 1404 for use by the processor(s) 1402 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 14, the datastore(s) may include, for example, purchase history information, user action information, user profile information, a database linking search queries and user actions, and other information.

The processor(s) 1402 may be configured to access the memory 1404 and execute computer-executable instructions loaded therein. For example, the processor(s) 1402 may be configured to execute computer-executable instructions of the various program module(s), applications, engines, or the like of the computing device 1400 to cause or facilitate various operations to be performed in accordance with one or more embodiments of the disclosure. The processor(s) 1402 may include any suitable processing unit capable of accepting data as input, processing the input data in accordance with stored computer-executable instructions, and generating output data. The processor(s) 1402 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 1402 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 1402 may be capable of supporting any of a variety of instruction sets.

Referring now to functionality supported by the various program module(s) depicted in FIG. 14, the charging connector abnormality detection module(s) 1426 may include computer-executable instructions, code, or the like that responsive to execution by one or more of the processor(s) 1402 may perform functions including, but not limited to, performing any functionality associated with the dynamic product summary images as described herein, and the like (for example, processing image data to identify physical abnormalities associated with a charging connector, providing an indicating of a physical anomaly, causing to send a signal to actuate a locking mechanism to lock or unlock the charging connector, and/or any other function described herein or otherwise.).

Referring now to other illustrative components depicted as being stored in the data storage 1420, the O/S 1422 may be loaded from the data storage 1420 into the memory 1404 and may provide an interface between other application software executing on the computing device 1400 and hardware resources of the computing device 1400. More specifically, the O/S 1422 may include a set of computer-executable instructions for managing hardware resources of the computing device 1400 and for providing common services to other application programs (e.g., managing memory allocation among various application programs). In certain example embodiments, the O/S 1422 may control execution of the other program module(s) to dynamically enhance characters for content rendering. The O/S 1422 may include any operating system now known or which may be developed in the future including, but not limited to, any server operating system, any mainframe operating system, or any other proprietary or non-proprietary operating system.

The DBMS 1424 may be loaded into the memory 1404 and may support functionality for accessing, retrieving, storing, and/or manipulating data stored in the memory 1404 and/or data stored in the data storage 1420. The DBMS 1424 may use any of a variety of database models (e.g., relational model, object model, etc.) and may support any of a variety of query languages. The DBMS 1424 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the computing device 1400 is a mobile device, the DBMS 1424 may be any suitable light-weight DBMS optimized for performance on a mobile device.

Referring now to other illustrative components of the computing device 1400, the input/output (I/O) interface(s) 1406 may facilitate the receipt of input information by the computing device 1400 from one or more I/O devices as well as the output of information from the computing device 1400 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the computing device 1400 or may be separate. The I/O devices may further include, for example, any number of peripheral devices such as data storage devices, printing devices, and so forth.

The I/O interface(s) 1406 may also include an interface for an external peripheral device connection such as universal serial bus (USB), FireWire, Thunderbolt, Ethernet port or other connection protocol that may connect to one or more networks. The I/O interface(s) 1406 may also include a connection to one or more of the antenna(e) 1434 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, ZigBee network, etc.

The computing device 1400 may further include one or more network interface(s) 1408 via which the computing device 1400 may communicate with any of a variety of other systems, platforms, networks, devices, and so forth. The network interface(s) 1408 may enable communication, for example, with one or more wireless routers, one or more host servers, one or more web servers, and the like via one or more of networks.

The antenna(e) 1434 may include any suitable type of antenna depending, for example, on the communications protocols used to transmit or receive signals via the antenna(e) 1434. Non-limiting examples of suitable antennas may include directional antennas, non-directional antennas, dipole antennas, folded dipole antennas, patch antennas, multiple-input multiple-output (MIMO) antennas, or the like. The antenna(e) 1434 may be communicatively coupled to one or more transceivers 1412 or radio components to which or from which signals may be transmitted or received.

As previously described, the antenna(e) 1434 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 1434 may additionally, or alternatively, include a Wi-Fi antenna configured to transmit or receive signals in accordance with established standards and protocols, such as the IEEE 802.11 family of standards, including via 2.4 GHz channels (e.g., 802.11b, 802.11g, 802.11n), 5 GHz channels (e.g., 802.11n, 802.11ac), or 60 GHz channels (e.g., 802.11ad). In alternative example embodiments, the antenna(e) 1434 may be configured to transmit or receive radio frequency signals within any suitable frequency range forming part of the unlicensed portion of the radio spectrum.

The antenna(e) 1434 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 1412 may include any suitable radio component(s) for—in cooperation with the antenna(e) 1434—transmitting or receiving radio frequency (RF) signals in the bandwidth and/or channels corresponding to the communications protocols utilized by the computing device 1400 to communicate with other devices. The transceiver(s) 1412 may include hardware, software, and/or firmware for modulating, transmitting, or receiving—potentially in cooperation with any of antenna(e) 1434—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 1412 may further include hardware, firmware, or software for receiving GNSS signals. The transceiver(s) 1412 may include any known receiver and baseband suitable for communicating via the communications protocols utilized by the computing device 1400. The transceiver(s) 1412 may further include a low noise amplifier (LNA), additional signal amplifiers, an analog-to-digital (A/D) converter, one or more buffers, a digital baseband, or the like.

The sensor(s)/sensor interface(s) 1410 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

The optional speaker(s) 1414 may be any device configured to generate audible sound. The optional microphone(s) 1416 may be any device configured to receive analog sound input or voice data.

It should be appreciated that the program module(s), applications, computer-executable instructions, code, or the like depicted in FIG. 14 as being stored in the data storage 1420 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the computing device 1400, and/or hosted on other computing device(s) accessible via one or more networks, may be provided to support functionality provided by the program module(s), applications, or computer-executable code depicted in FIG. 14 and/or additional or alternate functionality. Further, functionality may be modularized differently such that processing described as being supported collectively by the collection of program module(s) depicted in FIG. 14 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 14 may be implemented, at least partially, in hardware and/or firmware across any number of devices.

It should further be appreciated that the computing device 1400 may include alternate and/or additional hardware, software, or firmware components beyond those described or depicted without departing from the scope of the disclosure. More particularly, it should be appreciated that software, firmware, or hardware components depicted as forming part of the computing device 1400 are merely illustrative and that some components may not be present or additional components may be provided in various embodiments. While various illustrative program module(s) have been depicted and described as software module(s) stored in data storage 1420, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

1. An electric vehicle supply equipment (EVSE) system comprising:
a charging connector holster comprising:
a first aperture configured to receive a first charging connector for an electric vehicle;
a locking mechanism comprising a motor, one or more gears, and a control arm; and
an image capture device;
at least one memory that stores computer-executable instructions; and
one or more processors configured to access the memory and execute the computer-executable instructions to:
identify, based on first image data received from the image capture device, a physical abnormality associated with the first charging connector, wherein the physical abnormality comprises at least one of: physical damage to the first charging connector and debris lodged in the first charging connector; and
cause to send, based on identifying the physical abnormality, a first signal to actuate the control arm of the locking mechanism from a first position to a second position, wherein the locking mechanism prevents the first charging connector from being removed from the charging connector holster while the control arm is in the second position;
determine, based on second image data received from the image capture device, that the physical abnormality is no longer present; and
cause to send, based on the determination that the physical abnormality is no longer present, a second signal to actuate the locking mechanism from the second position to the first position, wherein the locking mechanism prevents the first charging connector from being removed from the charging connector holster while in the first position.

2. The system of claim 1, wherein the control arm further comprises a locking indicator, wherein the charging connector holster further comprises a masking element, wherein the locking indicator is visible while the locking mechanism is in the first position, and wherein the locking indicator is hidden behind the masking element while the locking mechanism is in the second position.

3. The system of claim 1, wherein the charging connector holster further comprises a protrusion, wherein the first charging connector further comprises a latch, wherein the latch is configured to engage with the protrusion, and wherein the locking mechanism is configured to prevent the latch from disengaging from the protrusion while in the second position.

4. The system of claim 1, wherein the charging connector holster further comprises a wiring harness including one or more connectors, wherein the one or more connectors are configured to send a first signal when the locking mechanism is in the first position and a second signal when the locking mechanism is in the second position.

5. An electric vehicle supply equipment (EVSE) system comprising:
a holster comprising:
a first aperture configured to receive a first charging connector for an electric vehicle;
a first locking mechanism; and
an image capture device;
at least one memory that stores computer-executable instructions; and
one or more processors configured to access the memory and execute the computer-executable instructions to:
identify, based on first image data received from the image capture device, a physical abnormality associated with the first charging connector; and
cause to send, based on identifying the physical abnormality, a first signal to actuate the first locking mechanism from a first position to a second position, wherein the first locking mechanism prevents the first charging connector from being removed from the holster while in the second position.

6. The system of claim 5, wherein the one or more processors are further configured to execute the computer-executable instructions to:
receive a signal indicating a request to unlock the first charging connector from the holster; and
cause to send a second signal to actuate the first locking mechanism from the second position to the first position, wherein the first locking mechanism prevents the first charging connector from being removed from the holster while in the first position.

7. The system of claim 5, wherein the first locking mechanism further comprises a locking indicator, wherein the holster further comprises a masking element, wherein the locking indicator is visible while the first locking mechanism is in the first position, and wherein the locking indicator is hidden by the masking element while the first locking mechanism is in the second position.

8. The system of claim 5, wherein the holster further comprises a protrusion, wherein the first charging connector further comprises a latch, wherein the latch is configured to engage with the protrusion, and wherein the first locking mechanism is configured to prevent the latch from disengaging from the protrusion while in the second position.

9. The system of claim 5, wherein the holster further comprises a wiring harness including one or more connectors, wherein the one or more connectors are configured to send a first signal when the first locking mechanism is in the first position and a second signal when the first locking mechanism is in the second position.

10. The system of claim 5, wherein the system further comprises a bulkhead, wherein the holster is mounted to the bulkhead.

11. The system of claim 5, further comprising a second aperture configured to receive a second charging connector and a second locking mechanism.

12. The system of claim 11, wherein the one or more processors are further configured to execute the computer-executable instructions to:
identify, using the first image data, a first target icon located on the first charging connector; and
determine that the physical abnormality is associated with the first charging connector instead of the second charging connector based on the first target icon.

13. An electric vehicle supply equipment (EVSE) apparatus holster comprising:
a holster configured to receive a first charging connector for an electric vehicle;
a first locking mechanism configured to actuate from a first position to a second position, wherein the first locking mechanism prevents the first charging connector from being removed from the holster while in the second position; and
an image capture device configured to capture image data of the first charging connector.

14. The EVSE apparatus of claim 13, first locking mechanism configured to actuate from the first position to the second position based on an indication of a physical abnormality associated with the first charging connector.

15. The EVSE apparatus of claim 14, wherein the physical abnormality is identified based on the image data of the first charging connector.

16. The EVSE apparatus of claim 13, wherein the first locking mechanism comprises a motor, one or more gears, and a control arm.

17. The EVSE apparatus of claim 16, wherein the control arm further comprises a locking indicator, wherein the holster further comprises a masking element, wherein the locking indicator is visible while the first locking mechanism is in the first position, and wherein the locking indicator is hidden behind the masking element while the first locking mechanism is in the second position.

18. The EVSE apparatus of claim 13, wherein the holster further comprises a protrusion, wherein the first charging connector further comprises a latch, wherein the latch is configured to engage with the protrusion, and wherein the first locking mechanism is configured to prevent the latch from disengaging from the protrusion while in the second position.

19. The EVSE apparatus of claim 13, wherein the holster further comprises a wiring harness including one or more connectors, wherein the one or more connectors are configured to send a first signal when the first locking mechanism is in the first position and a second signal when the first locking mechanism is in the second position.

20. The EVSE apparatus of claim 13, further comprising a second aperture configured to receive a second charging connector and a second locking mechanism.
